(19) United States
(12) Patent Application Publication
(10) Pub. No.: US 2005/0030621 A1
(43) Pub. Date: Feb. 10, 2005

(54) Stereoscopic display unit and stereoscopic vision observation device

(76) Inventors: Susumu Takahashi, Iruma-shi (JP); Kazuo Morita, Tokyo (JP)

Correspondence Address: Arnold International, P.O. Box 129, Great Falls, VA, 22066, US

(21) Appl. No.: 10/891,057

(22) Filed: Jul. 15, 2004

Related U.S. Application Data
(63) Continuation-in-part of application No. 10/270,641, filed on Oct. 16, 2002.

(30) Foreign Application Priority Data
Jul. 15, 2003 (JP) 2003-274802
Dec. 4, 2003 (JP) 2003-406275

(51) Int. Cl. G02B 27/22

(52) U.S. Cl. 359/464

(57) ABSTRACT

A stereoscopic display unit and stereoscopic vison observation device are disclosed that include a projector that projects left-eye and right-eye images via two apertures that serve as exit pupils of the projector onto the same image surface and a display panel. The display panel is positioned at, or in the vicinity of, the image surface, and includes an optical element having an optical axis and positive optical power that conjugates the exit pupils of the projector so as to form exit pupils for observation. The optical axis of the optical element having positive optical power is offset so as to lie outside the surface area of the display panel and a diffuser is provided at, or in the vicinity of, the image surface for the purpose of enlarging the exit pupils for observation to thereby form enlarged exit pupils for observation. Various other features are also disclosed.

This is a continuation-in-part of applicants' co-pending U.S. patent application Ser. No. 10/270,641 entitled “Three-Dimensional Observation Apparatus” filed Oct. 16, 2002. In addition, this application claims benefit of priority under 35 U.S.C. 119 from Japanese Patent Application number 2003-274802 filed Jul. 15, 2003, and from Japanese Patent Application number 2003-406275 filed Dec. 4, 2003, both of which are hereby incorporated by reference.

### BACKGROUND OF THE INVENTION

The present invention relates to a three-dimensional (hereinafter 3-D) observation apparatus wherein individuals need not wear glasses in order to view 3-D images using the apparatus. A prior art example of such a 3-D observation apparatus is disclosed in Japanese Laid-Open Patent application S51-24116. As shown in FIG. 20, this 3-D observation apparatus includes two display devices 51R, 51L, two concave mirrors 52R, 52L, and a concave mirror 53 that faces the two concave mirrors 52R, 52L. The concave mirrors 52R, 52L have the same radius of curvature and a common center of curvature. The observer's right and left eyes 54R, 54L are also shown in FIG. 20.

FIG. 21 is a side view of the 3-D observation apparatus in FIG. 20. FIG. 21 shows the unit upside down, for convenience, in order to explain the apparatus and with the display devices omitted. In FIG. 21, 54R′ (54L′), 54R″ (54L″) are conjugate points to the viewer's respective right and left eyes within the 3-D observation apparatus. The display devices 51R (51L) shown in FIG. 20 are disposed somewhere between the infinity positions PR(∞) (PL(∞)) and the focal point PR(f) (PL(f)). When the display devices 51R (51L) are disposed at the infinity positions PR(∞) (PL(∞)), light emerging from the display devices 51R (51L) is reflected on the concave mirrors 52R (52L) and is imaged at the front focal point A of the concave mirror 53. The light is then again reflected on the concave mirror 53 where it is collimated. The collimated light then reaches the viewer's pupil 54R (54L). When the display devices 51R (51L) are positioned at the front focal positions PR(f) (PL(f)) of the concave mirrors 52R (52L), light emerging from the display devices 51R (51L) is reflected on the concave mirrors 52R (52L) where it is collimated. The collimated light is again reflected on the concave mirror 53 and imaged at the rear focal point B of the concave mirror 53. Then, the light reaches the viewer's eyes where it is viewed as an enlarged image. Such a conventional observation apparatus does not use a beam splitter (i.e., a half-reflecting mirror), and thus bright 3-D images can be seen.

As in the 3-D observation apparatus described above, a large shift between the viewing points and the focal points spoils the stereoscopy observation. In this 3-D observation apparatus, the concave mirrors that produce distortion in images face each other. These two facing concave mirrors should be positioned so that their respective distortions cancel each other. Positioning errors of the concave mirrors determine the magnitude of image distortion and focal point shift. To avoid these problems, the two concave mirrors should have accurately formed surfaces that are precisely positioned. This results in a high cost for manufacturing and assembling the concave mirrors. Because the viewer faces the concave mirrors, a shift in the viewing position leads to a large image distortion, giving the viewer less freedom of viewing position and posture, which is inconvenient to the viewer. The exit pupils can be enlarged to improve freedom of movement during observation. However, larger concave mirrors are required in association with the enlarged exit pupil in the prior art observation apparatus discussed above. This will enlarge the entire 3-D observation apparatus.

U.S. Pat. No. 5,712,732 discusses, beginning at column 1, line 41, a prior art stereoscopic display wherein stereo pair images are projected, at slightly different angles, onto the back of a Fresnel lens so as to create a 3-D viewing experience for an observer without glasses. However, there is no suggestion that the Fresnel lens have its optical axis offset from the center of the Fresnel lens, as in the present invention.

U.S. Pat. No. 5,614,941 discloses a prior art stereoscopic display wherein stereo pair images are projected, at slightly different angles, onto a viewing screen that includes an array of cylinder lenses, a diffuser, and a Fresnel lens so as to create a 3-D viewing experience for an observer without glasses. Once again, however, there is no suggestion that the Fresnel lens have its optical axis offset from the center of the Fresnel lens, as in the present invention.

### BRIEF SUMMARY OF THE INVENTION

The objects of the present invention are to provide an individual 3-D observation apparatus and a 3-D observation system that do not require the observer to wear glasses and which provide bright images, more freedom of positioning of the viewer's head, and reduced aberrations due to misalignment of the viewer's pupils from the optical axes of the exit pupils. An additional object of the invention is to allow the viewer to assume one or more comfortable viewing postures during a 3-D observation.

### BRIEF DESCRIPTION OF THE DRAWINGS

The present invention will become more fully understood from the detailed description given below and the accompanying drawings, which are given by way of illustration only and thus are not limitative of the present invention, wherein:

FIGS. 1(a) and 1(b) are illustrations to explain the principle of the 3-D observation apparatus of the present invention, with FIG. 1(a) being a transmission-type 3-D observation apparatus and FIG. 1(b) being a reflection-type 3-D observation apparatus;

FIG. 2 is an illustration to explain the principle of enlarging the viewing pupils in the 3-D observation apparatus of the present invention;

FIGS. 3(a) and 3(b) show an embodiment of the 3-D observation apparatus of the present invention, with FIG. 3(a) being a top view and FIG. 3(b) being a side view;

FIGS. 4(a) and 4(b) show another embodiment of the 3-D observation apparatus of the present invention, with FIG. 4(a) being a perspective view and FIG. 4(b) being a side view;

FIG. 5 is a side view that shows the embodiment of FIG. 4 in more detail;

FIGS. 6(a), 6(b)) and 6(c) are side views to schematically illustrate three respective modifications to the embodiment illustrated in FIG. 5;

FIGS. 7(a) and 7(b) are side views to schematically illustrate two additional embodiments of the 3-D observation apparatus of the present invention;

FIGS. 8(a) and 8(b) illustrate a reflection-type display panel applicable to the reflection-type 3-D observation apparatus of the present invention, with FIG. 8(a) being a perspective view and FIG. 8(b) being a side view;

FIGS. 9(a) and 9(b) are schematic illustrations of another example of a reflection-type display panel applicable to the reflection-type 3-D observation apparatus of the present invention, with FIG. 9(a) being a side view and FIG. 9(b) being an enlarged view of the diffuser;

FIG. 10 is a side view to schematically show another example of a reflection-type display panel applicable to the reflection-type 3-D observation apparatus of the present invention;

FIG. 11 is a side view to schematically illustrate another example of the reflection-type display panel applicable to the reflection-type 3-D observation apparatus of the present invention;

FIGS. 12(a)-12(c) show another example of a reflection-type display panel that is applicable to the reflection-type 3-D observation apparatus of the present invention, with FIG. 12(a) being a side view, FIG. 12(b) being a side view that illustrates a modification to FIG. 12(a), and FIG. 12(c) being an expanded view of the diffusing film layer 5d shown in FIGS. 12(a) and 12(b);

FIGS. 13(a)-13(c) show other examples of a reflection-type display panel that is applicable to the 3-D observation apparatus of the present invention, with FIG. 13(a) being a side view, FIG. 13(b) being a side view that illustrates a modification of the panel shown in FIG. 13(a), and FIG. 13(c) being an expanded view of the layer 5e that illustrates diffusion of light;

FIGS. 14(a) and 14(b)) show an arrangement of a reflection-type 3-D observation apparatus of the present invention having any of the strictures shown in the embodiments discussed above, with FIG. 14(a) being a perspective view and FIG. 14(b) being a top view;

FIG. 15 shows the configuration of an embodiment of a 3-D observation system that uses the 3-D observation apparatus of the present invention;

FIG. 16 shows an application of the 3-D observation apparatus of the present invention;

FIG. 17 shows another application of the 3-D observation apparatus of the present invention;

FIG. 18 shows another application of the 3-D observation apparatus of the present invention;

FIG. 19 shows another application of the 3-D observation apparatus of the present invention;

FIG. 20 schematically illustrates the structure of a prior art, reflection-type 3-D observation apparatus;

FIG. 21 is a side view of the device shown in FIG. 20;

FIG. 22(a) shows the basic construction, partially in block diagram form, of a stereoscopic vision observation device that includes a stereoscopic display unit according to another embodiment of the present invention, and FIG. 22(b) shows a modified example of the stereoscopic display Unit Shown in FIG. 22(a);

FIG. 23 is a side view that shows in greater detail the construction of the stereoscopic display unit show in FIG. 22(a);

FIG. 24 is an explanatory diagram which illustrates, using unfolded light paths of a reflective display, the formation of exit pupils for observation during two-dimensional observation;

FIG. 25(a) is an explanatory diagram that illustrates, using unfolded light paths of a reflective display, the formation of exit pupils for observation during a three-dimensional observation, with FIG. 25(a) being a view from above, FIG. 25(b) illustrates the intensity distribution within the right and left exit pupils for observation with a diffuser being used, and FIG. 25(c) illustrates the intensity distribution within the right and left exit pupils for observation without a diffuser being used;

FIG. 26 is a side view that shows the construction layout of a stereoscopic display unit shown in FIG. 23, but from the other side;

FIGS. 27(a) and 27(b) show more details concerning the construction of the display panel 22 shown in FIG. 26, with FIG. 27(a) being a cross-sectional view of the display panel 22, and with FIG. 27(b) being a front view of the Fresnel surface of the display panel 22;

FIG. 28 shows a different example of a display panel 22 construction wherein a holographic optical element (HOE) is used as a diffuser for enlarging the exit pupils for observation in the stereoscopic display unit shown in FIG. 23;

FIGS. 29(a) and 29(b) show another example of a display panel 22 construction wherein a diffusion plate, that provides a scattering effect to a luminous flux due to scattering when the luminous flux enters and exits, is combined with the Fresnel mirror in the display panel shown in FIG. 26, with FIG. 29(a) being a side view of the construction layout and FIG. 29(b) being an explanatory diagram that shows the scattering of a luminous flux caused by the diffusion plate;

FIG. 30 is an explanatory diagram that shows, using the stereoscopic display unit of FIG. 23, the relationship between the pixel pitch (in linear units) of the image display on the display Surface of the display panel and the distance on the surface of the display panel that corresponds to one minute of arc (which corresponds to the resolution of a human eye), as well as the relationship between the pixel pitch (in linear units) of the image display and the diameter of what is termed the circle of confusion on the display surface of the display panel that results from the scattering of light;

FIG. 31 (a) shows the Fresnel surface of the display panel, and FIG. 31 (b) is an explanatory diagram that shows the size relationship of an image that is projected onto the display surface of the display panel versus the size of the display panel, wherein the display panel size is smaller than that of the projected picture range;

FIG. 32 is side view that shows the construction layout of a stereoscopic display unit according to another embodiment of the present invention;

FIGS. 33(a) and 33(b) show the display panel 22 according to the embodiment shown in FIG. 32, with FIG. 33(a) being a cross-sectional view of the display panel 22 and FIG. 33(b) being a front view of the Fresnel surface of the display panel 22;

FIGS. 34(a) and 34(b) show a Fresnel concave mirror, with FIG. 34(a) being a front view and FIG. 34(b) being a cross-sectional view; and

FIG. 35 is an explanatory diagram used for explaining the manner in which what is termed herein as the “aperture ratio” is determined.

### DETAILED DESCRIPTION

The 3-D observation apparatus of the present invention projects light beams that convey left and right stereo image data through respective apertures. The light beams converge to form overlapped images within a common region. Images for viewing are formed at the exit pupils of the 3-D observation apparatus by an imaging means that is formed of either a Fresnel lens or Fresnel mirror that is positioned substantially at the common region. In addition, a diffuser for enlarging the pupils is preferably provided substantially at the common region. The diffuser should not enlarge the projected images of the two apertures to the point that the two apertures overlap. In this way, light fluxes having parallax that are projected onto a display surface from the two apertures are imaged so that the exit pupils are enlarged but do not overlap. Thus, the exit pupils serve to display left and right images having different parallax, to the respective left and right eye of a viewer, thereby providing a 3-D viewing experience to a viewer without the need for the viewer to wear glasses in order to experience the 3-D effect.

With the structure of the 3-D observation apparatus of the present invention as described above, in which the left and right images are projected onto a common region, the convergence point for the light passing through the left and right pupils is made to be coincide with the image surface of the left and right images so that the left and right images overlap. With the left and right apertures enlarged and projected onto the viewing pupil positions, more freedom of pupil positions is obtained, thereby allowing the viewer to be in a more comfortable posture during observation. The diffuser enables the size of the pupils of the projectors to be reduced. This results in the image quality being improved, as well as enables the size of the projectors to be reduced. The diffuser is also used to reduce differences in aberrations in the projection optics, and it serves to make the light more uniform, which improves the 3-D viewing experience.

The imaging means for forming the left and right images, as well as the pupil enlarging effect provided at the left and right exit pupils, also reduces aberrations in the 3-D image. In the 3-D observation apparatus of the present invention, the imaging optical system for creating the exit pupils and the diffuser for enlarging the exit pupils can be provided as components on a display panel. The display panel can be planar, in which case it may be observed from a non-normal position to reduce image aberrations. Also, the display panel can be curved to further reduce image aberrations.

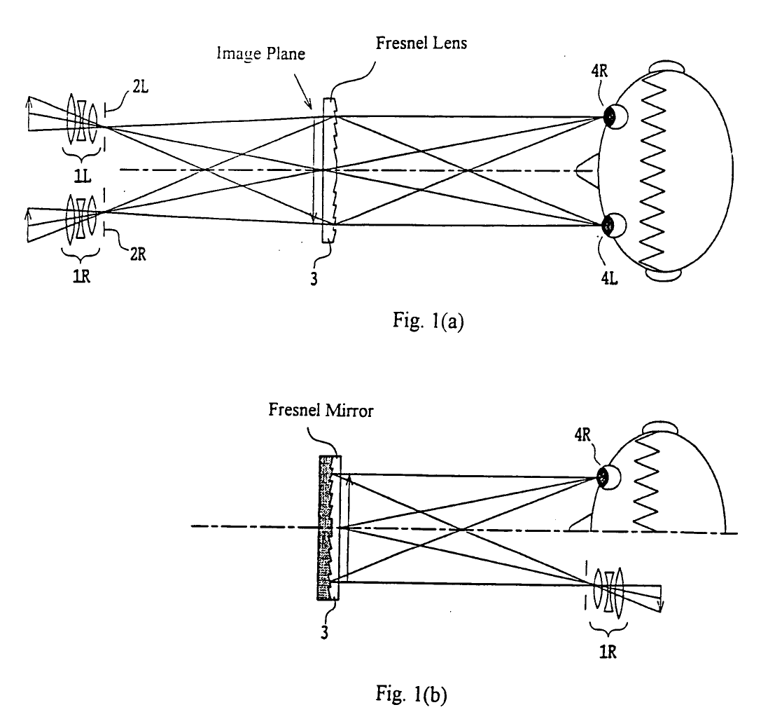

Various embodiments of the present invention will now be described in detail. FIGS. 1(a) and 1(b) show ray paths of two embodiments of a 3-D observation apparatus according to the present invention, with FIG. 1(a) illustrating a transmission-type 3-D observation apparatus and FIG. 1(b) illustrating a reflection-type 3-D observation apparatus. In FIG. 1(b), only the optical structure for conveying images to the right eye is shown (i.e., the structure for the left eye is omitted, for convenience). The 3-D observation apparatus shown in FIGS. 1(a) and 1(b) includes a projection optical system having projectors 1R, 1L, and an imaging optical system 3. Although not illustrated in FIGS. 1(a) and 1(b), a diffuser may be used with the 3-D observation apparatus of the invention, either as a separate component or combined with another component. The projectors 1R, 1L are arranged to project images from the two apertures 2R, 2L onto a common region.

The imaging optical system 3 is arranged to form the images from the two apertures 2R, 2L of the projection optical systems at the viewer's pupils 4R, 4L. The diffuser serves to enlarge the viewing pupils. The imaging optical system 3 and the diffuser are positioned at a common region, Such as a display surface. The display surface is positioned to coincide with the image plane of the images projected from the projection devices. The imaging optical system 3 is formed of a Fresnel lens in the case of a transmission-type 3-D observation apparatus, and of a Fresnel minor in the case of a reflection-type 3-D observation apparatus. The Fresnel mirror or Fresnel lens is arranged to form the images from the two apertures 2R, 2L at the viewer's pupils, respectively. Having the Fresnel surface positioned substantially at the image plane keeps the Fresnel surface from impairing the image quality. Further, unlike conventional concave mirrors, the Fresnel surface takes up much less space, since the overall form of such a mirror is similar to that of a flat surface.

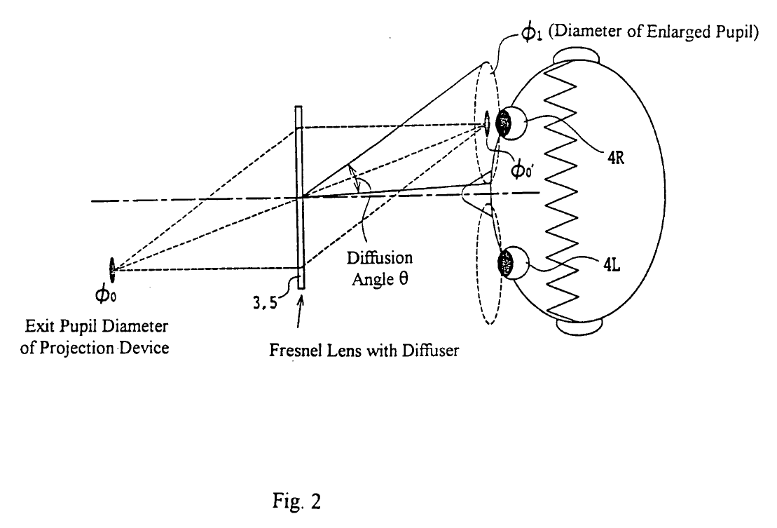

FIG. 2 is an illustration to show the principle of enlarging the viewing pupils in the 3-D observation apparatus of the present invention. In FIG. 2, the structure of a transmission-type 3-D observation apparatus is shown. A diffuser 5 is positioned at or near a flat display surface along with the imaging optical system 3. The imaging optical system 3 serves to form images having a diameter of φₒ′ of the pupils of the left and right projection devices having a diameter of φₒ. These images serve as observation exit pupils at which an observer may view the images. The diffuser 5 provides a diffusion effect that enlarges the images of the pupils of the left and right projection devices to a diameter φ₁. The left and right exit pupils as enlarged by the diffuser 5 are not enlarged to such an extent that the left and right exit pupils overlap. Thus, crosstalk is prevented. Light transits the diffuser 5 when positioned at the display surface only once in a transmission-type 3-D observation apparatus. However, the diffuser is twice as effective in a reflection-type 3-D observation apparatus (not shown in FIG. 2), since the light transits the diffuser twice.

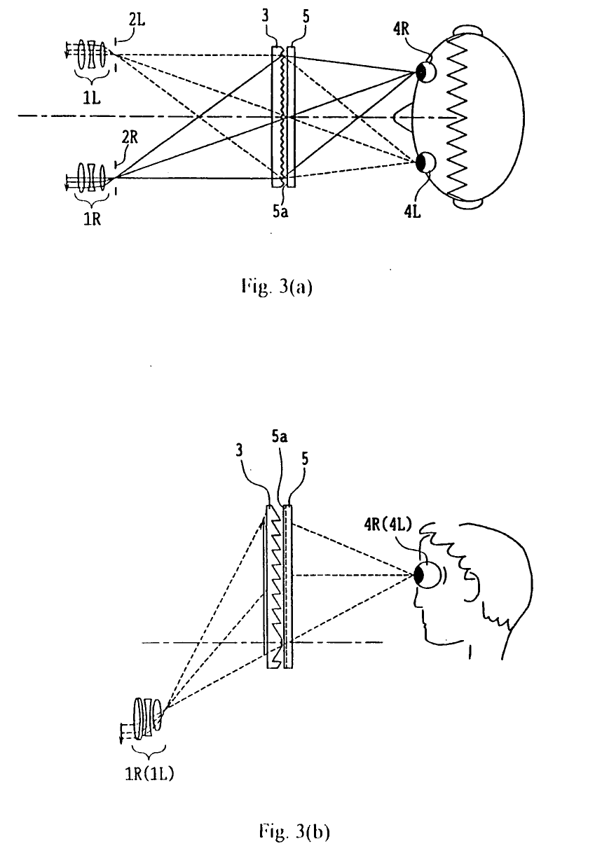

FIGS. 3(a) and 3(b) illustrate an embodiment of the 3-D observation apparatus of the present invention, with FIG. 3(a) being a top schematic view and FIG. 3(b) being a side schematic view. The 3-D observation apparatus of this embodiment is of the transmission-type. An imaging optical system 3 (here formed as a Fresnel lens) is positioned substantially at a display surface or region for forming overlapping images from the apertures 2R, 2L. The projector device in this case is formed of separate projectors 1R, 1L that project image-bearing light through the apertures. The Fresnel lens 3 has its prism-like Fresnel surface on the side of the viewer. A diffuser 5 for enlarging the pupils is formed of a diffusing plate and is positioned near the Fresnel lens 3. The diffuser 5 has a diffusing surface 5a facing the Fresnel lens surface. In this embodiment, the Fresnel lens surface is positioned substantially at the image surface of images projected using the projection devices. Therefore, the Fresnel lens surface does not significantly affect the image quality. The diffusing Surface 5a is positioned near the Fresnel lens surface in order to reduce blurriness caused by the diffuser.

The transmission-type display panel of this example consists of a de-centered optical system. In other words, the Fresnel lens has an optical axis that is de-centered with respect to the center of the Fresnel lens surface. As is shown in FIG. 3(b), the optical axis of the Fresnel lens is lower than the center position of the Fresnel lens surface, which has positive refractive power. The de-centered arrangement of the Fresnel lens in this embodiment is useful in positioning the projector so that it does not obstruct the view of the observer. The diffusing surface 5a and the Fresnel surface are preferably arranged to be as near to one another as possible so as to maintain a high quality image.

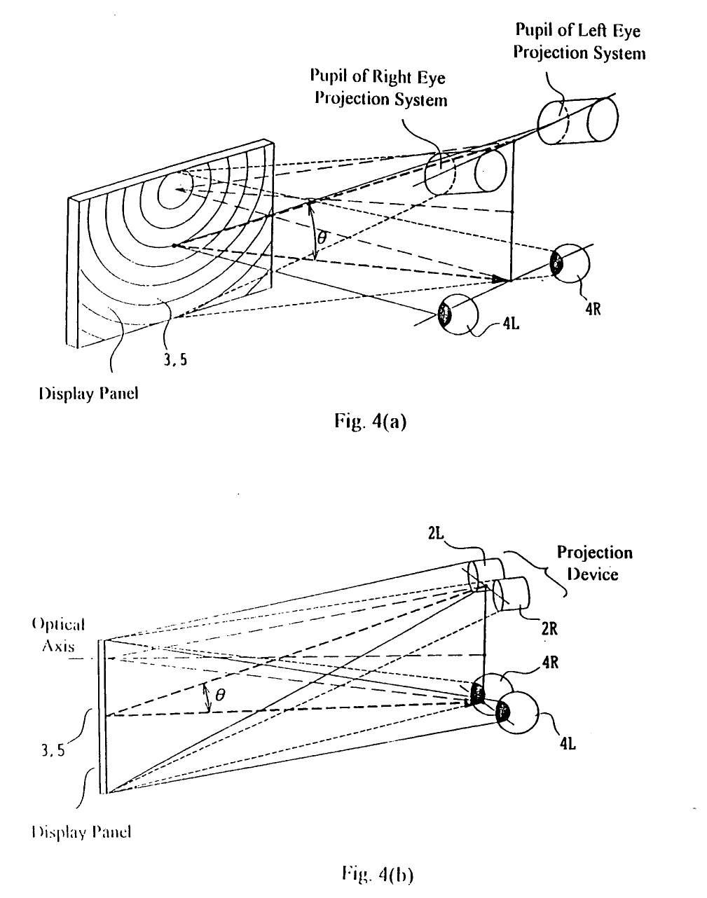

FIGS. 4(a) and 4(b) show another embodiment of the 3-D observation apparatus of the present invention, with FIG. 4(a) being a perspective view and FIG. 4(b) being a side view. The 3-D observation apparatus of this embodiment is of the reflection-type. The display panel is formed of a Fresnel mirror 3 that is an imaging optical system for forming images from the apertures of the projection devices 2R, 2L at the viewer's pupils 4R, 4L, and a diffuser 5 for enlarging the pupils. For the reflection-type 3-D observation apparatus, optical members should be arranged in a way that the projection devices and the viewer's face do not interfere with each other. It is better for the viewer that he/she directly faces the display panel, so that the line of sight is normal to the display panel surface. In this embodiment, θ is defined as the angle between the optical axis of the projected light that is incident onto the display panel and the optical axis of the display light emerging from the center of the display panel. In addition, according to the present invention, the optical axis of the Fresnel mirror 3 is de-centered in the upward or downward direction (upward in FIG. 4) in relation to the center of the display panel.

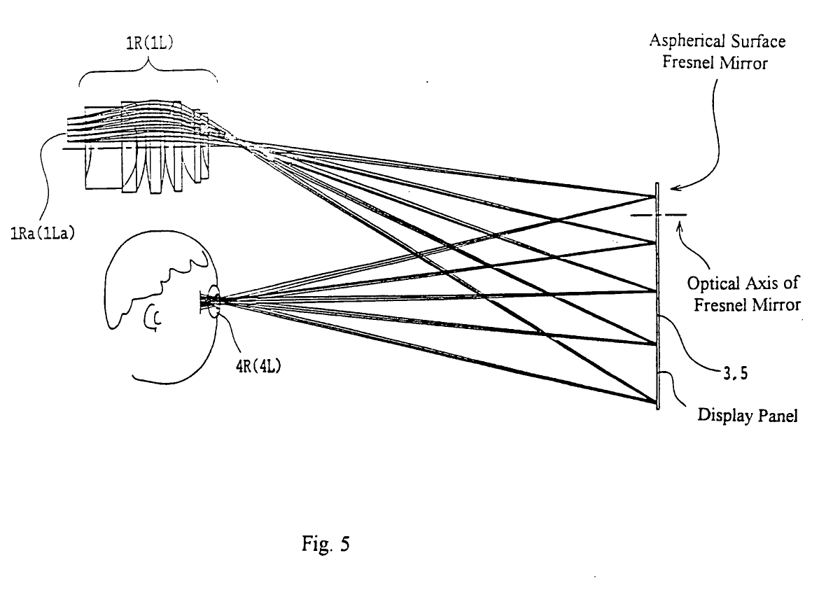

FIG. 5 is a side view to show the embodiment illustrated in FIG. 4 in more detail. In FIG. 5, the projection optical systems 1R (1L) of the projection device are formed of spherical lenses and the respective display surfaces 1Ra (1La) are de-centered from the optical axes of the lenses so that the projection device and tile viewer's head do not physically interfere with each other. Preferably, the display panel 3,5 is positioned and oriented so that the line of sight is normal to the display panel substrate. Once again, in this embodiment, the display panel is a Fresnel mirror surface. It is preferred that the observer views the display panel from the direct front. However, the display panel can be used at an angle of as much as 30°, and high quality images can be assured when the display panel is within 15° of being normal to the line of sight.

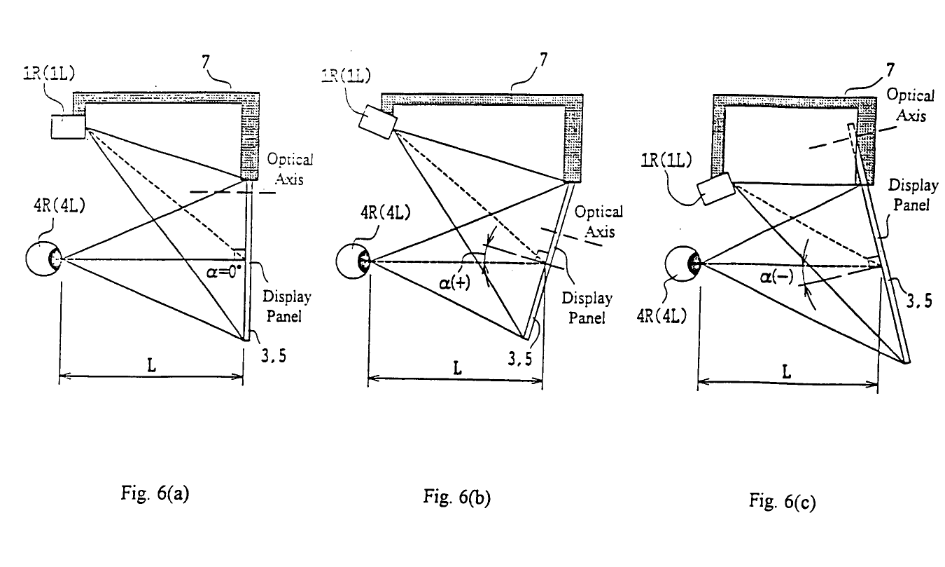

FIGS. 6(a)-6(c) are side views that show possible modifications to the embodiment shown in FIG. 5. In FIGS. 6(a)-6(c), the viewer's line of sight is horizontal. In these alternative embodiments, adjustment is made for the display panel and the viewer's pupils 4R (4L) by a combination of the inclination of the display panel surface and the de-centering magnitude of the optical axis of the de-centered Fresnel lens surface. A supporting arm 7 for supporting the two projection devices and the display panel is shown in FIGS. 6(a)-6(c). The inclination α of the display panel surface is the angle between the line connecting the center of the display panel to the viewer's pupil versus a line drawn orthogonal to the display panel at its center. For comfortable observation, this angle is preferably less than 30°. The angle α of the display panel surface is zero degrees in the 3-D observation apparatus of FIG. 6(a), and 30 degrees in each of the 3-D observation apparatuses of FIGS. 6(b) and 6(c). Among the embodiments shown in FIGS. 6(a)-6(c), the structures shown in FIGS. 6(a) and 6(b) are preferred because they provide more natural viewing and require less de-centerinig of the optical axis of the Fresnel lens from the center of the Fresnel lens surface.

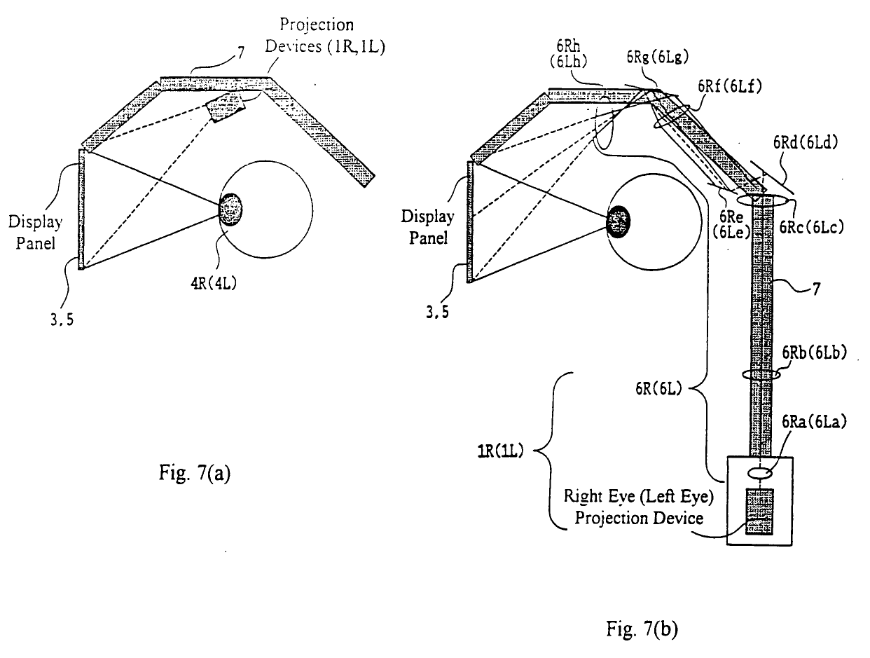

FIGS. 7(a) and 7(b) are side views which schematically show the structure of another embodiment of the 3-D observation apparatus of the present invention. The 3-D observation apparatus of this embodiment is of the reflection-type. The 3-D observation apparatus in FIG. 7(a) is formed of two projection devices and a display panel having a Fresnel mirror 3 and a diffuser 5. The viewing pupils are separated to the left and right and enlarged to form images at the viewer's pupil positions. The 3-D observation apparatus in FIG. 7(b) is formed of the projection optical systems 1R (1L) that are also used in FIG. 7(a) plus additional relay systems. Thus, in addition to the projection devices included in FIG. 7(a), a relay system 6R (6L) is provided in the supporting arm 7 for Supporting the display panel. In the embodiment of FIG. 7(b), the relay system 6R (6L) is formed of the lenses 6Ra-6Rc (6La-6Lc), mirrors 6Rd (6Ld), 6Re (6Le), lenses 6R mirrors 6Rg (6Lg), and lenses 6Rh (6Lh). With this structure, the projection device and the viewer's head can be sufficiently separated so that any physical interference between them is avoided.

Examples of the display panel used in the 3-D observation apparatus of the present invention will now be described in detail.

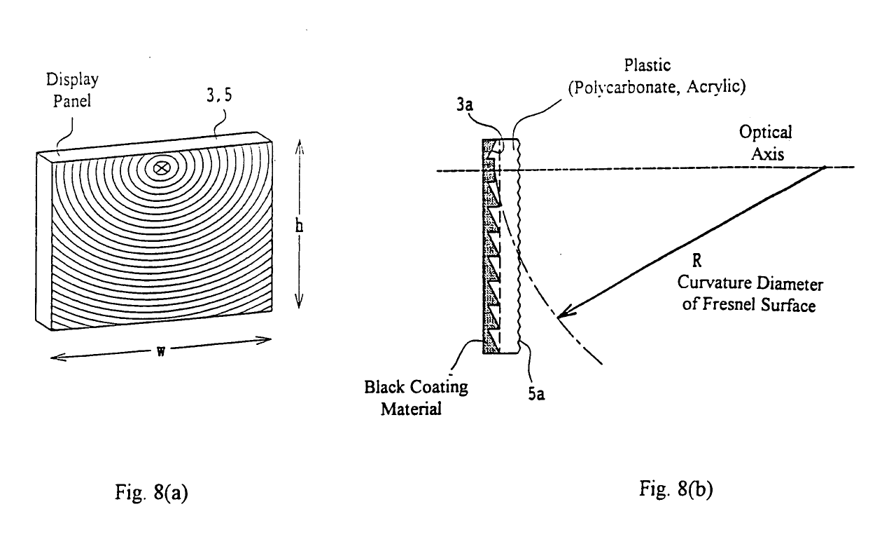

FIGS. 8(a) and 8(b) are illustrations to show an example of a reflection-type display panel that may be used in the reflection-type 3-D observation apparatus of the present invention, with FIG. 8(a) being a perspective view and FIG. 8(b) being a side view to schematically show the structure of the display panel. The display panel of this example is formed of a Fresnel surface 3a and a diffusing surface 5a. The diffusing surface 5a has randomly arranged concave surfaces. The Fresnel surface 3a and diffusing surface 5a are formed into an integral unit. For example, plastic resins such as polycarbonate or acrylic may be used to mold a Fresnel surface and a diffusing surface. The Fresnel surface 3a may then be coated with aluminum to make it reflective. A black coating material may be applied to the back of the Fresnel surface so as to form a protective coating. The Fresnel surface 3a of the display panel now serves to form images by reflection of the apertures of the two projection devices so that a viewer may view the images by placing his eyes at the pupil positions. The diffusing surface 5a serves to enlarge the exit pupils for easier viewing.

The display panel shown in FIGS. 8(a) and 8(b) has the structure of a de-centered, Fresnel back-surface mirror. However, the Fresnel mirror may instead be a front-surface mirror. The radius of curvature R of the Fresnel surface 3a of the front-surface or back-surface mirrors will now be discussed. If the Fresnel mirror is designed as a back-surface mirror, the radius of curvature R should equal 2n+f; however, when the Fresnel mirror is designed to be a front-surface minor, the radius of curvature R should equal 2f, where n is the refractive index and f is the focal length. Accordingly, by employing a Fresnel back-surface mirror as illustrated in FIGS. 8(a) and 8(b), the radius of curvature can be made larger, which is advantageous in that smaller aberrations are generated in the course of imaging the pupils. Furthermore, the display panel of this example uses an a spherical Fresnel surface 3a with its radius of curvature increased toward the periphery. With this structure, the a spherical Fresnel surface advantageously serves to further reduce aberrations generated in the course of imaging the pupils.

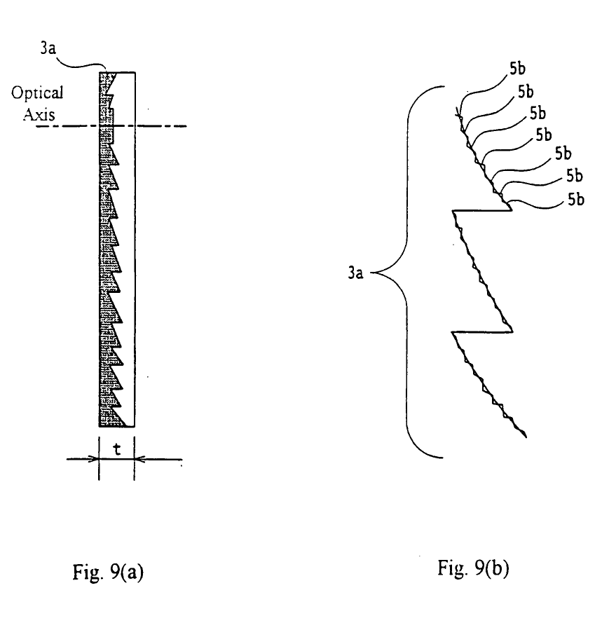

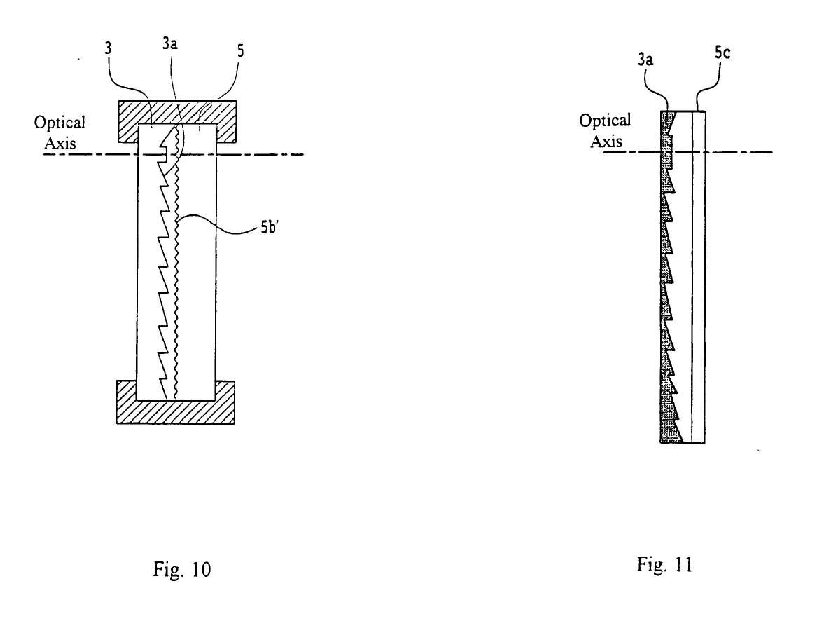

FIGS. 9(a) and 9(b) illustrate another example of a reflection-type display panel that is applicable to the reflection-type 3-D observation apparatus of the present invention, with FIG. 9(a) being a side view to schematically show the structure, and FIG. 9(b) being an enlarged view of the diffuser. In this example, the diffuser is formed by integrally molding fine concave surfaces 5b as is shown in FIG. 9(b) at the Fresnel surface. This structure can serve in lieu of using a diffuser 5a as shown in FIG. 8(b). Referring again to FIGS. 9(a) and 9(b), the Fresnel surface 3a has a reflective coating applied to form a back-surface Fresnel reflecting mirror. In this example, the overall shape of the display panel is that of a flat surface. This enables an anti-reflection coating (not illustrated) to be easily applied to the top surface. Light passes through the diffuser twice in the reflection-type display panel shown in FIG. 8(b). On the other hand, using the Fresnel surface 3a having fine concave surfaces 5b as shown in FIG. 9(b) results in the light being diffused only once by the diffuser. This causes the projected light to have less blurring, and thereby increases the quality of the images that can be viewed.

FIG. 10 is a side view to schematically show another example of a reflection-type display panel applicable to the reflection-type 3-D observation apparatus of the present invention. In the display panel of this example, the imaging optical system is formed of a front-surface Fresnel mirror, and the diffuser 5 is formed of a diffusing plate having a rough surface 5b′. With the display panel of this example, the Fresnel mirror surface 3a is on the front surface and is arranged to be very near the rough surface 5b′. This can significantly reduce the blurring of images. Alternatively, the display panel can be a front-surface Fresnel mirror with a diffusing film laminated thereto in lieu of using a diffusing plate, and with its diffusing surface very near to the Fresnel surface.

FIG. 11 is a side view to schematically show another example of a reflection-type display panel applicable to the reflection-type 3-D observation apparatus of the present invention. The display panel of this example is formed of a de-centered Fresnel back-surface mirror (as illustrated in FIG. 8b), but with a diffusing film 5c laminated thereto. The diffusing film 5c can be of the internal scattering-type or can use roughness formed on the front surface.

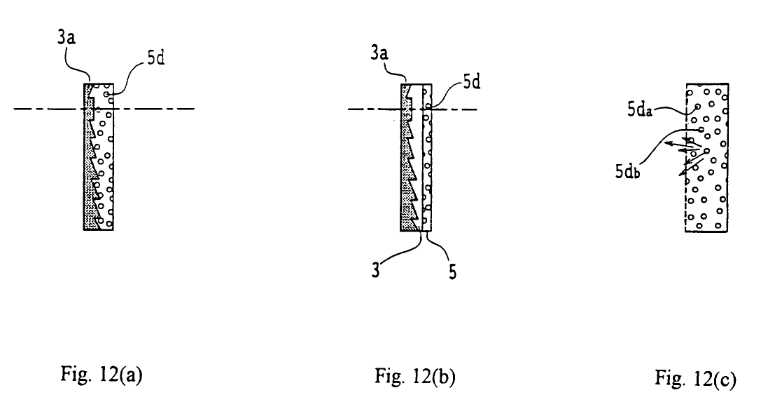

FIGS. 12(a)-12(c) are illustrations that show other examples of a reflection-type display panel applicable to the reflection-type 3-D observation apparatus of the present invention, with FIG. 12(a) being a side view to schematically show the structure, FIG. 12(b) being an illustration to schematically show a modification to the structure shown in FIG. 12(a), and FIG. 12(c) being an illustration to show diffusion in the display panel. As best shown in FIG. 12(c), the display panels of this example are of the internal diffusion-type, wherein the diffusing member is formed of a plastic matrix mixed with transparent fine grains 5da, 5db that have different refractive indexes. Light passing through the fine grains 5da, 5db is scattered. The display panel illustrated in FIG. 12 (a) is formed of an optical member having a Fresnel surface 3a forming a de-centered Fresnel back-surface mirror combined with plastic matrix material that is mixed with transparent fine grains. The de-centered Fresnel back-surface mirror and the internal diffusion-type diffusing member are integrally molded. The display panel illustrated in FIG. 12(b) is formed of a de-centered Fresnel back-surface mirror and an internal diffusion-type diffusion plate formed by a plastic matrix being mixed with transparent fine grains. The de-centered Fresnel back-surface mirror and the internal diffusion-type diffusion plate are arranged very near one another. In the structure illustrated in FIG. 12(b), an internal diffusing film 5d is laminated onto the surface of a de-centered Fresnel back-surface mirror in lieu of using a diffusing plate.

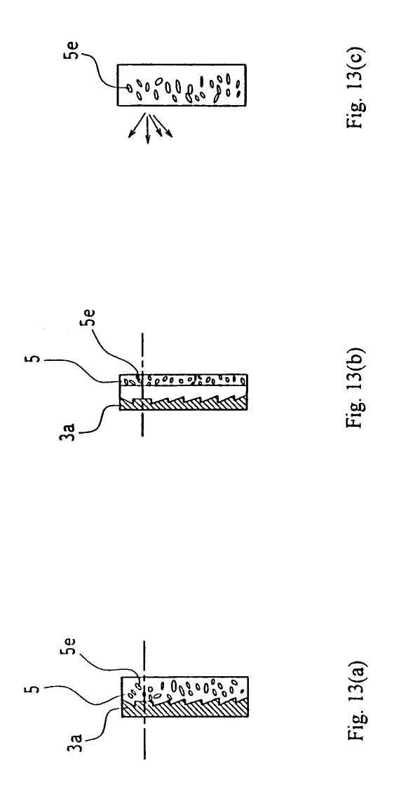

FIGS. 13(a)-13(c) are illustrations to show other examples of a reflection-type display panel applicable to the reflection-type 3-D observation apparatus of the present invention, with FIG. 13(a) being a side view to schematically show the structure, FIG. 13(b) being an illustration to schematically show a modification to the structure shown in FIG. 13(a), and FIG. 13(c) being an illustration to show the internal diffusion. The display panels shown in FIGS. 13(a)-13(c) are internal diffusion-type display panels in which the diffusion means 5 is a polymerized liquid crystal.

Polymerization is used to solidify liquid crystal. The present example uses this phenomenon. Polymerized liquid crystal 5e is birefringent and has an unstable orientation. When photo-polymerized, it is solidified with a random internal orientation as is shown in FIG. 13(c). The display panel in FIG. 13(a) is formed of an optical member having a de-centered Fresnel back-surface mirror integrally molded with polymerized liquid crystal. The display panel in FIG. 13(b) is formed of a de-centered Fresnel back-surface mirror laminated on, or positioned near, a diffusion plate consisting of polymerized liquid crystal. A diffusing film consisting of polymerized liquid crystal can be laminated on the surface of the de-centered Fresnel back-surface mirror in place of the polymerized liquid crystal diffusion plate. With the display panel of this example having the structure as discussed above, the birefringent polymerized liquid crystal 5e is solidified with a random internal orientation. Light is slightly refracted according to the polarized direction. Scattering in the polymerized liquid crystal yields a diffusion effect as a whole. The display panel of this example can use a flat surface so that the diffusion effect due to internal dispersion is more efficiently used. This also makes it easy to clean when it gets dirty and to provide an anti-reflection coating for preventing reflection of ambient light.

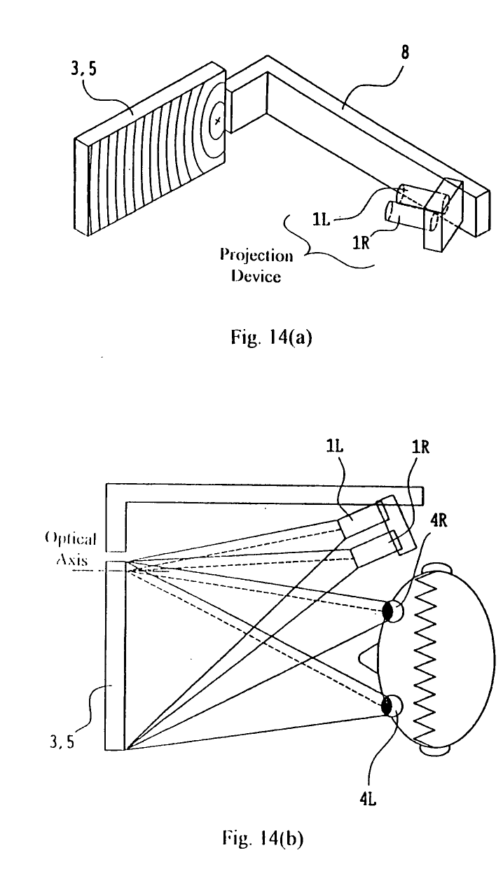

FIGS. 14(a) and 14(b) are illustrations to show the arrangement of the reflection-type 3-D observation apparatus of the present invention having any of the structures shown in the examples above, with FIG. 14(a) being a perspective view and FIG. 14(b) being a top view. In the 3-D observation apparatus of this embodiment, the display panel is of the reflection-type. The display panel 3,5 and two projection devices 1R, 1L are integrally attached to a supporting member 8. The two projection devices 1R, 1L may be positioned on either the right or left side of the display panel 3,5, but for convenience of illustration are positioned on the right in FIGS. 14(a) and 14(b). The Fresnel reflecting surface of the display panel has its optical axis de-centered with respect to the center of the display surface. The de-centering may be either to the right or left, but for convenience of illustration is illustrated as being to the right in FIGS. 14(a) and 14(b). A sufficient angle is provided between the optical axis of the light entering the center of the display panel from the right and left projection devices versus the optical axis of the light emerging from the display panel to the viewer's respective right or left pupils 4R (4L) so that the projection devices and the viewer's head do not interfere with each other.

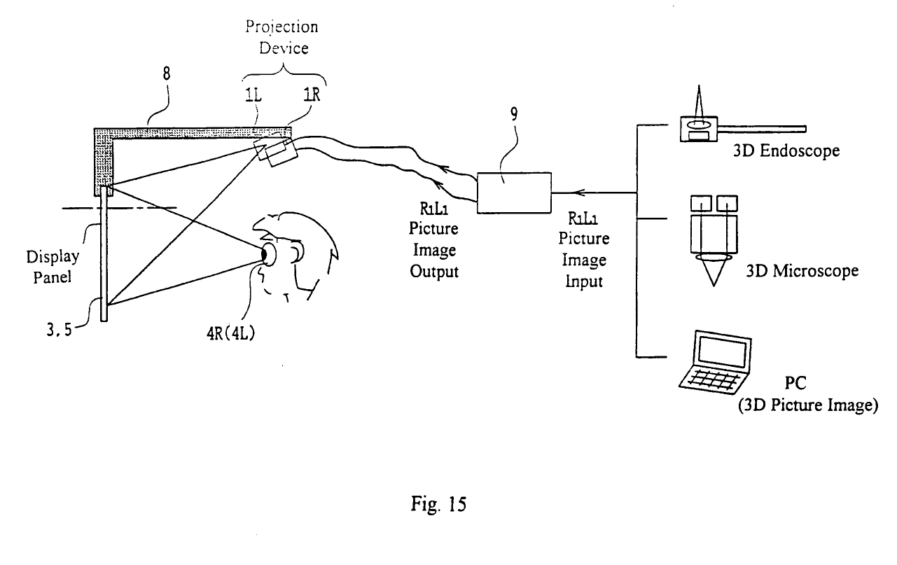

FIG. 15 is an illustration to schematically show the configuration of an embodiment of a reflection-type 3-D observation system using the 3-D observation apparatus of the present invention. However, the 3-D observation system of this embodiment can be applicable to all the 3-D observation apparatus of the present invention. The left and right projection devices of this embodiment are connected to a projection device control unit 9. The projection device control unit 9 selectively receives stereo pair image data, such as from a 3-D endoscope or 3-D microscope, and transfers this data to left and right projection devices. The projection device control unit 9 of this embodiment also can be used to receive 3-D parallax images generated by a personal computer and to then display the images. Applications of the 3-D observation apparatus of the present invention having the structure above will now be described.

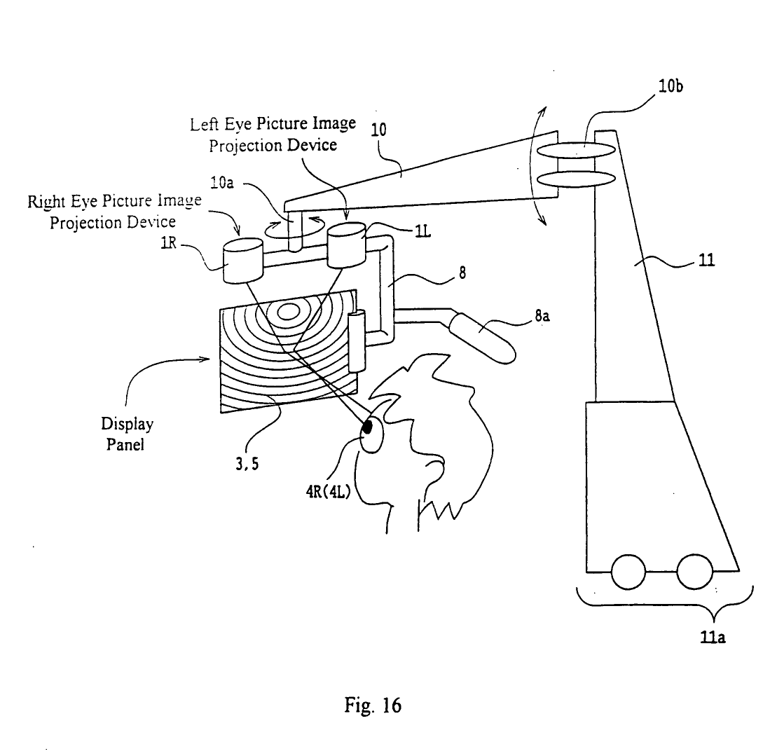

FIG. 16 is an illustration to show an application of the 3-D observation apparatus of the present invention, wherein a reflection-type observation apparatus is used. The observation apparatus includes a display panel 3,5, left and right projection devices 1L,1R integrally attached to a holding member 8, a supporting arm 10 for supporting the holding member 8, and a supporting body 11 for supporting the supporting arm 10. With this 3-D observation apparatus, images having different parallax are projected onto the display panel from the left and right projection devices and reflected thereon. The reflected images are formed in the viewer's left and right pupils 4L, 4R with the viewing pupils enlarged. The holding member 8 is rotatable in the direction indicated by the arrow about the axis of a joint 10a. The supporting arm 10 is rotatable in the direction indicated by the arrow at the joints 10b. By rotating the holding member 8 and supporting arm 10 in the desired direction, the viewer may change his/her posture during observation. The holding member 8 has an operating handle 8a for easy grasping. The supporting body 11 has casters 11 a so that the supporting body can be easily moved.

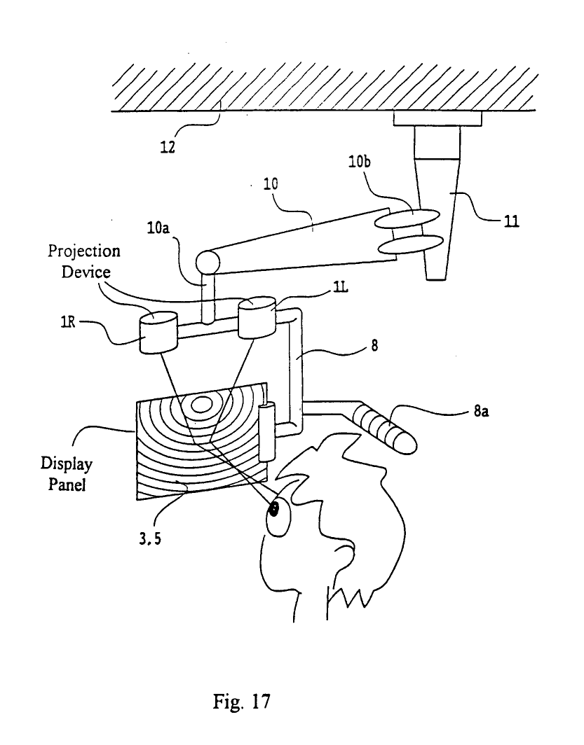

FIG. 17 is an illustration to show another application of a 3-D observation apparatus of the present invention. In this application, the supporting body 11 is attached to the ceiling in order to save space.

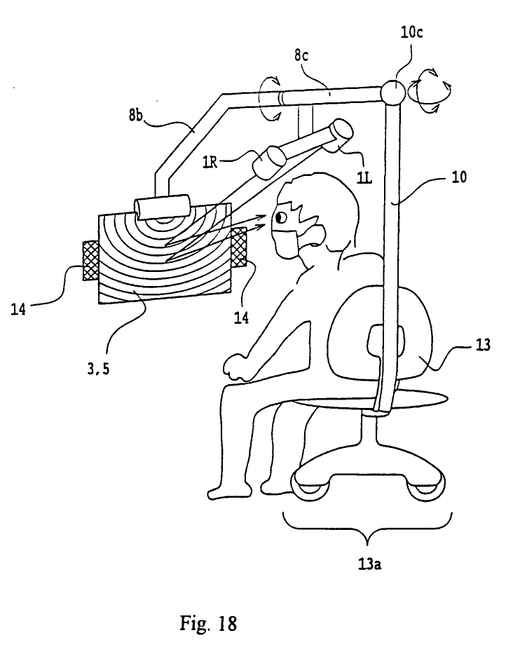

FIG. 18 is an illustration to show another application of the 3-D observation apparatus of the present invention. This application has the supporting arm 10 attached to a surgical chair 13. Here, the display panel is attached to a holding member 8b and the projection devices 1L, 1R are attached to a holding member 8c. The holding member 8b is rotatable relative to the holding member 8c. In this way, the direction of the display panel can be changed relative to the projection devices. The holding member 8c to which the projection devices are attached is rotatable in the two directions shown via a joint 10c. In this way, the display panel and projection devices can be re-oriented at will. Handles 14 are provided on the right and left sides of the display panel. In this way, re-orientation is easily accomplished without directly touching the display portion of the display panel. The surgical chair 13 has casters 13a so that the chair can be easily moved to change one's observation position.

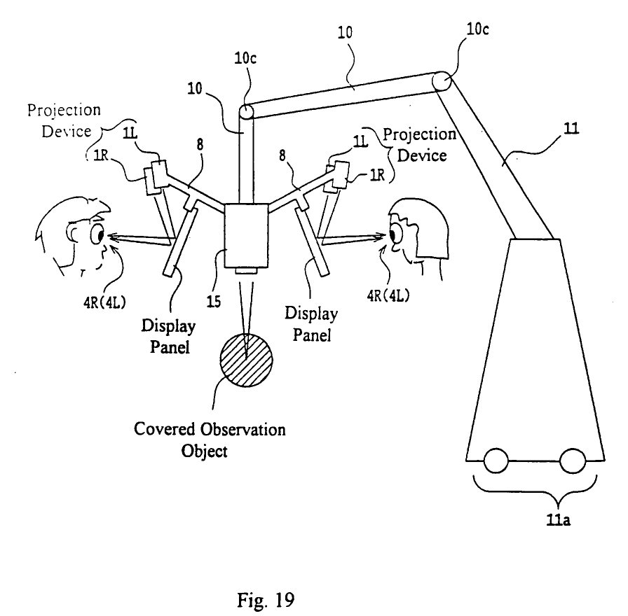

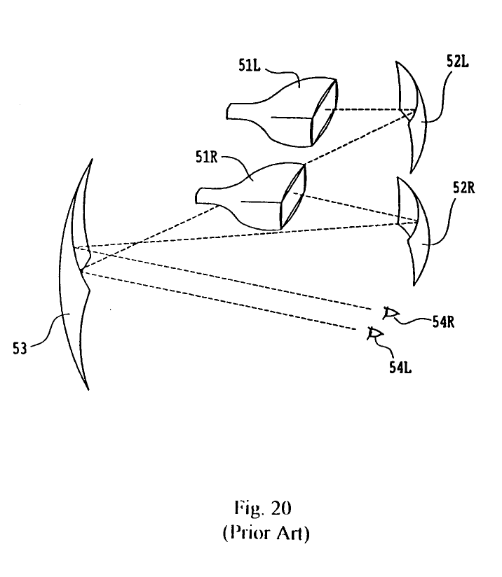

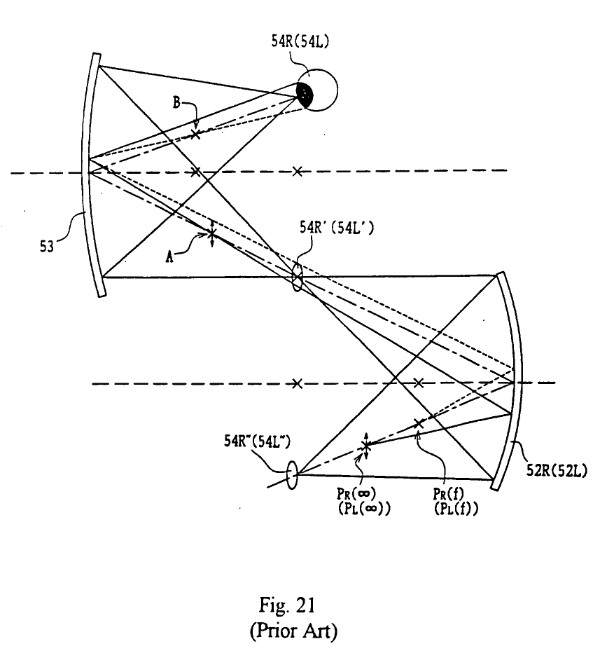

FIG. 19 is an illustration to show another application of the 3-D observation apparatus of the present invention. In this application, two 3-D observation apparatuses, each formed of projection devices 1L, 1R and a display panel attached to a holding member 8, are attached by means of the holding member 8 to the image input part 15 of a surgical microscope having a supporting body 11, casters 11 a and a supporting arm 10 that is rotatable by means of joints 10c. Two cameras are contained in the image input part 15 of the surgical microscope. Input images are transferred to the respective projection devices of the 3-D observation apparatus. In this way, 3-D images from the surgical microscope are made simultaneously available to more than one viewer.

The 3-D observation apparatus applications shown in FIGS. 16 to 19 may be used in various fields, such as surgical microscopy, endoscopy, medical 3-D data imaging, 3D CAD imaging, and so on, or even as a computer game machine. Furthermore, the structures used in reflection-type 3-D observation apparatuses of the embodiments above are also applicable to transmission-type 3-D observation apparatuses using a transmission-type display panel as shown in FIG. 1(a). In addition, the image display panel can instead be a DMD.

The stereoscopic vision observation device according to the present invention projects images through two apertures onto the same image surface. A display panel that includes an optical element having positive optical power is arranged at, or in the vicinity of, the image surface. The two apertures are conjugated (i.e., imaged) at observation exit pupils by the optical element having positive optical power, and the optical element scatters the light incident on it so as to form enlarged observation exit pupils for easy viewing. The optical element having positive optical power may be formed of either a concave Fresnel mirror or a convex Fresnel lens. The optical axis of the optical element having positive optical power is constructed so as to be offset from the display panel (i.e., outside the display surface of the display panel) so as to avoid unwanted noise in the images and to prevent unnecessary interference between the image projectors and the observer as well as between the image projectors and other personnel in the vicinity of the observer.

Furthermore, the stereoscopic display unit according to the present invention is characterized by the following Condition (1) being satisfied:
Φ=10·Δproj Condition (1)
where

Φ is the diameter of the circle of confusion caused by the diffuser, which is determined by the thickness of the panel, as well as by the scattering angle, and

Δ proj is the pixel pitch (measured in linear units) of the image display surface when projected onto the display panel.

Further, the stereoscopic display unit according to the present invention is characterized by including:

(a) a projection means that projects images through two apertures onto the same image Surface;

(b) a display panel that includes an optical element having positive optical power positioned at or nearby the image surface and which conjugates the two apertures of the projection means so as to form observation exit pupils at which images may be observed; and,

(c) a diffuser, which scatters light incident thereon so as to thereby enlarge the observation exit pupils.

The optical element having positive optical power may include a Fresnel optical element. When this is the case, it is desirable that the optical axis of the Fresnel optical element is constructed so as to be offset from the display surface of the display panel. In addition, it is desirable that the following Condition (2) is satisfied:
P<10·Δeye Condition (2)
where

P is the groove pitch (in linear units) of the Fresnel optical element, and

Δ eye is the diameter of the circle of confusion for the human eye observing the display panel surface from the position of the observation exit pupils.

Because a human observer can discern two points as being separate points only when the angle the two points subtend from the eye equals one minute of arc or more, the diameter Δ eye of the circle of confusion at the surface of the display panel that results from such visual acuity of a human observer is substantially equal to the number of radians corresponding to one minute of arc times the distance that the observer's eyes are from the display panel.

Further, the stereoscopic vision observation device according to the present invention is characterized by the fact that it includes the stereoscopic display unit of the present invention and an image input device.

By satisfying the above Conditions (1) and (2), an image display unit and a stereoscopic vision observation device are provided having a high quality image. Furthermore, the image display unit and stereoscopic vision observation device are user-friendly with regard to enabling a three-dimensional observation to be observed with less fatigue experienced by the viewer and miniaturization of the image display unit and of the stereoscopic vision observation device can be realized.

Prior to explaining additional various embodiments of the invention in detail, the operation and efficacy of the present invention will be explained.

As described above, the stereoscopic display unit and the stereoscopic vision observation device according to the present invention are constructed by being equipped with a projection means that projects images via two apertures onto the same image surface, an optical element having positive optical power that is positioned at the image surface or nearby it and which conjugates (i.e., forms images of) these apertures at the respective observation exit pupil positions, and a diffuser which enlarges the observation exit pupils for observation beyond the magnification of the conjugated apertures produced by the optical element having positive optical power.

With the above-mentioned construction, an image that passes through each aperture is projected onto the image surface at or near the display panel, and images of the two apertures are formed at the observation exit pupils by the optical element having positive optical power. Further, the observation exit pupils are enlarged by the diffuser. The enlarging that occurs is such that none of the enlarged exit pupils for observation overlaps another enlarged exit pupil for observation. Consequently, a viewer can perceive stereoscopic images without having to wear special eyeglasses that would prevent the left-eye images from being seen by the right-eye, and vice-versa, within enlarged viewing areas.

According to the present invention, since the convergence position of a viewer's right and left eyes coincides with the in-focus position of the right and left projected images, an observer will not suffer from the undesirable feeling of disorientation that accompanies viewing images when the convergence position of the viewer's right and left eyes does not coincide with the in-focus position of the right and left projected images, respectively. Consequently, the viewer can comfortably perceive stereoscopic images of scenes without experiencing fatigue and/or a feeling of being disoriented, as often occurs when viewing stereo image pairs when the convergence position of the viewer's right and left eyes does not coincide with the in-focus positions of the right and left projected images, respectively. Further, because the images of the right and left apertures are enlarged at the positions of the enlarged exit pupils for observation, greater freedom in positioning the observer's eyes is provided. Thus, a viewer can view stereoscopic images while being able to change his viewing posture, which results in less fatigue.

Further, since a diffuser that accomplishes a scattering effect enlarges the observation exit pupils beyond that provided by the image magnification in forming the exit pupils for observation, the two apertures can be downsized, thereby improving image quality of the projected images as well as allowing the projector to be downsized.

Moreover, if the diffuser that accomplishes a scattering effect is positioned at or near the image surface, the distortion of the images due to aberrations of the optical system of the projectors can be eliminated. In other words, because the luminous flux can be made uniform on the display Surface due to the scattering effect of the diffuser, a viewer can observe an image which will not be distorted regardless of the positioning of the exit pupils for observation. Furthermore, even if a Fresnel optical element is used as the optical element having positive optical power so as to conjugate the apertures and thereby form observation exit pupils, no image quality deterioration will occur.

In addition, if a pupil enlargement function is provided by using a diffuser at the image surface to scatter the light, no image quality deterioration will occur as a result of the scattering. Therefore, in the stereoscopic display unit and the stereoscopic vision observation device according to the present invention, the optical element having positive optical power and the diffuser that scatters light so as to enlarge the observation exit pupils are arranged as components of the same display panel and at coinciding positions or very near one another. Moreover, their location should be at or near the image surface. This reduces the deterioration of image quality when the display panel is viewed from near the periphery of the observation exit pupils.

In addition, with the stereoscopic display unit and the stereoscopic vision observation device according to the present invention, the below-mentioned operation and effect can be obtained.

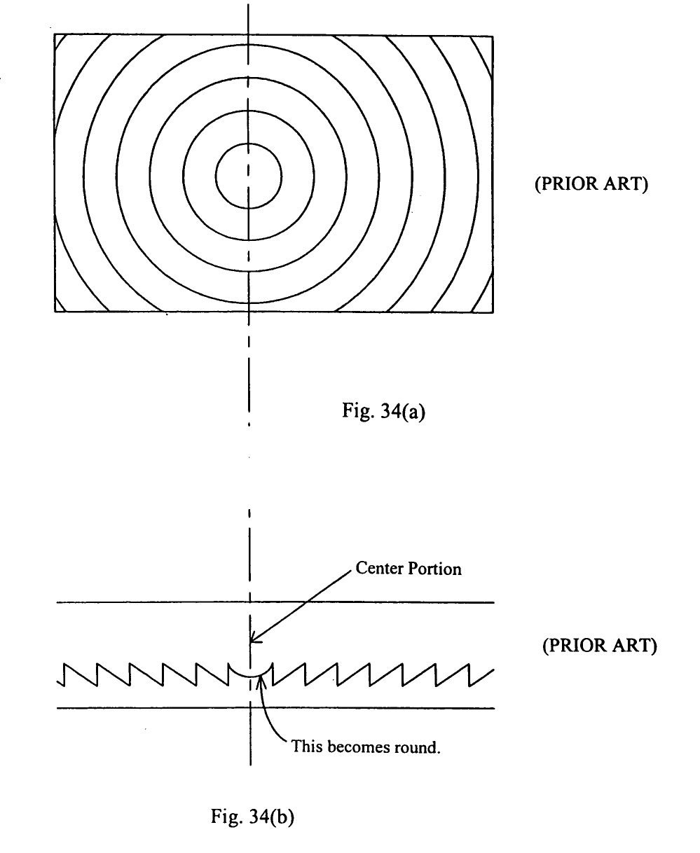

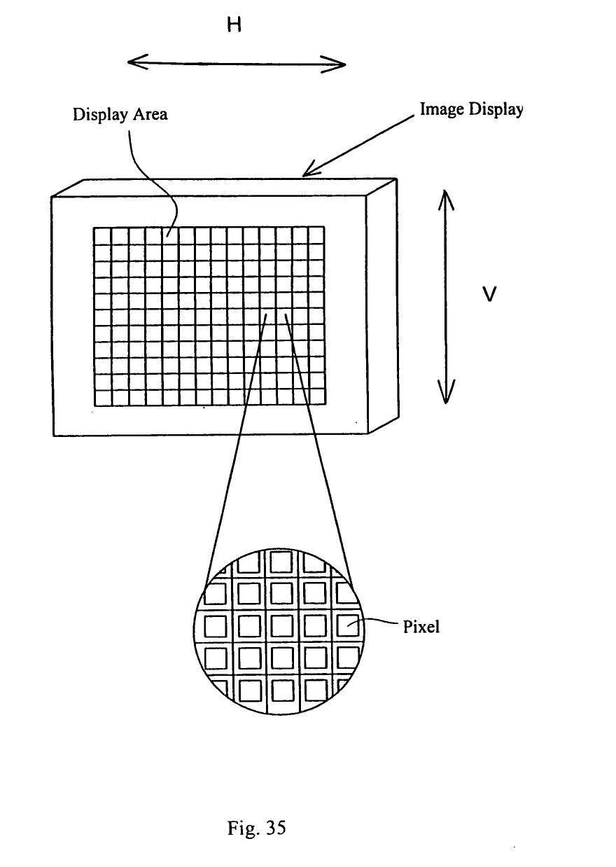

In the stereoscopic display unit and the stereoscopic vision observation device according to the present invention, when the positive optical component includes a Fresnel optical element, namely, either a concave Fresnel mirror or a convex Fresnel lens, the optical axis of the Fresnel optical element should be offset from the display surface of the display panel. Having such an offset not only prevents interference of persons with equipment in the vicinity of the surgical site, but it also provides higher quality images, as will be explained below in the case where the Fresnel optical element is formed as a Fresnel mirror.

Where a Fresnel mirror forms the optical element having positive optical power, the cross-sectional configuration of the groove in the center region (the region that the optical axis passes through, shown in FIG. 34(a)) of the Fresnel surface tends to become round, as shown in FIG. 34(b), due to the manufacturing process. Light that is then incident onto the groove portion and is reflected by the groove and converged, often causes the groove portion to appear too bright, as if it were a light source. In this manner, the quality of an image becomes deteriorated.

On the other hand, in the present invention, a Fresnel optical element having positive optical power is constructed such that its optical axis is offset from the display surface of the display panel. Thus, the light that is reflected by the groove is reflected in a direction that is not towards the observer's eyes. Thus, the groove portion in this case will not appear too bright.

Further, grooves that form the Fresnel surface are formed at a predetermined pitch on the Fresnel optical element, as shown in FIGS. 36(a) and 36(b). If the pitch (in terms of linear units) is. large, the grooves become easily noticeable, and the quality of an image is thus deteriorated. The smaller the pitch becomes, the less noticeable the grooves. Further, the noticeability of the grooves is affected by the observation distance. Since the angular resolution of a human eye is about one minute of arc, as noted above, when the groove pitch (in linear units) of the Fresnel optical element is made smaller than a distance on the surface of the display panel that corresponds to one minute of arc, the groove lines will not be noticeable and the image will not be degraded. Furthermore, it is preferable that the groove pitch of the Fresnel optical element be made small relative to the diameter Φ of the circle of confusion (i.e., the amount of blur) of the projected image. The amount of blur is dependent on the diffuser that causes the scattering and the distance between the diffuser and the display surface. Once again, it is desirable that the grooves of the Fresnel surface not be noticeable to the viewer, as this will degrade the quality of an image. Satisfying the above Conditions (1) and (2) ensures that a high quality stereoscopic image is perceived without the Fresnel grooves being noticeable to a viewer.

In the stereoscopic display unit and the stereoscopic vision observation device according to the present invention, it is preferable that what is termed herein as the ‘aperture ratio’ is 0.2 or more, with the aperture ratio being the summation of the areas of pixels that can be turned to a bright status divided by the display area, where the display area includes the areas that can be turned to a bright status as well as a portion around each pixel that forms a cell in an array of pixels that comprise the display, but excludes the border area of the display. If the aperture ratio becomes less than 0.2, boundary areas that surround each pixel appear as a grid pattern or as dot-shaped patterns when viewing the images become noticeable. Also, in the case where the difference between the groove pitch of the Fresnel optical element and the pixel pitch of the image display is small, a moir pattern will be generated. However, if the aperture ratio is designed to be 0.2 or more, the contrast of the moir pattern will be relatively weak.

In the stereoscopic display unit and the stereoscopic vision observation device according to the present invention, if the diffuser is comprised of a hologram film which accomplishes both a scattering effect and a refraction effect, a high quality three-dimensional image can be obtained.

In addition, in the stereoscopic display unit and the stereoscopic vision observation device, it is necessary that the display panel be viewed from an appropriate distance and from an appropriate viewing angle as determined by the observation exit pupils, and that these observation exit pupils be designed properly. For example, if the observation distance is less than about 150 mm, an extended duration of observation will result in eye fatigue due to the muscles used to focus the eye lens as well as the muscles used to move the eyes becoming tired. Therefore, it is necessary to form the exit pupils for observation such that the distance from the display panel to the pupil positions for observation is greater than 150 mm.

The longer the viewing distance, the smaller the angle of convergence and the less refractive power required of an observer's eyes. However, as the observation exit pupils are made to be more remote from the display, the display panel itself must be larger for the images to be seen clearly, which results in an inconvenience and increases the likelihood that other equipment in the operating room will interfere with the placement of the display panel. Consequently, in the stereoscopic display unit and the stereoscopic vision observation device according to the present invention, it is preferable that the distance from the display panel to the observation exit pupils is in the range of 150 mm-2000 mm.

In particular, in the case of performing an operation close at hand while a three-dimensional observation is conducted, it is preferable to have the display panel within a range of distance that provides a stereoscopic viewing sensation for direct viewing, thereby reducing the sense of incongruity that occurs where the observed images on the display panel are not at a distance that corresponds with the convergence angle of the displayed images. Therefore, from this point of view, it is desirable that the upper limit of the distance from the display panel to the observation exit pupil positions does not exceed 2000 mm.

Further, in the stereoscopic display unit and the stereoscopic vision observation device according to the present invention, from the view point of ease in conducting an observation, it is better that the angle that the display panel subtends from the viewer in the horizontal direction be greater than the angle that the display panel subtends in the vertical direction. Also, it is desirable that the angle that the display panel subtends in the horizontal direction be in the range of 6 degrees through 60 degrees. The lower limit of 6 degrees provides a minimum picture angle to ensure that a sufficient amount of information concerning the object is being conveyed to a viewer; the upper limit is to prevent the size of the display panel from becoming too large. In particular, during an operation it is often necessary to observe the site of the operation while observing images on the display panel. Thus, it is necessary to not only be able to observe the display panel itself, but also to observe the surgical site directly. As an alternative, the information displayed on the display panel can be information for better understanding the circumstances, such as the image of the surgical site as viewed from a different point of view.

In the stereoscopic display unit and the stereoscopic vision observation device according to the present invention, the display panel itself has a function that accomplishes the pupil enlargement effect by providing a scattering effect. Generally, such a scattering effect tends to degrade the resolution of the displayed images. However, in the present invention, degradation of the observed images is avoided by controlling the diameter Φ of the circle of confusion caused by the scattering. The diameter Φ of the circle of confusion depends on the scattering angle as well as on the thickness of the display panel. By keeping the diameter of the circle of confusion (i.e., the blur circle) small as compared with the amount of detail in the projected images, deterioration of image quality due to blur is maintained below the resolution limit of the eye.

If the projection means is miniaturized as much as possible by having the images of the apertures of the projection means magnified by the optical element having positive optical power when conjugating these apertures so as to from the observation exit pupils while at the same time enlarging the observation exit pupils using the diffuser, the diameter of the apertures in the projection means can be established smaller, thereby enabling the entire optical system to be miniaturized.

In the stereoscopic display unit and the stereoscopic vision observation device according to the present invention, it is preferable to construct the diameter of the exit pupils for observation in the range of 20 mm through 500 mm, from the point of view of securing a proper brightness. In addition, it is preferable to construct the diameter of the apertures in the projection means in the range of 5 mm through 50 mm, from the point of view of miniaturizing the size of the projection means.

The smaller the image display is, the smaller the optical construction of the projection means can become, under the circumstance of securing a given resolution. On the other hand, if the image display is constructed so that its area does not exceed 900 mm², the projection means can be miniaturized. In order to additionally miniaturize the projection means, the image display means should be constructed so that its area does not exceed 400 mm².

The image magnification in forming the observation exit pupils using the optical element having positive optical power should not be extremely reduced or enlarged. Moreover it is preferable to construct the image magnification in the range of 0.1 through 10. It is also preferable to construct the ratio of the area of the display panel surface at the image surface divided by the area of the projected image at the image surface so as to be in the range of 0.50 through 1.00, so as to avoid there being non-illuminated regions in the field of view.

The invention will now be discussed in general terms with reference to the drawings.

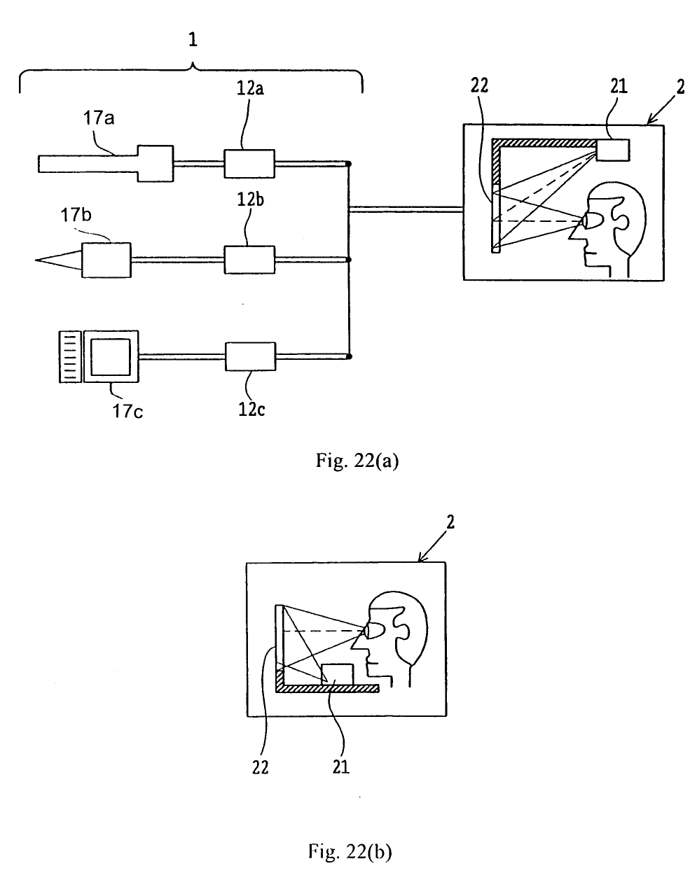

FIG. 22(a) shows the basic construction, partially in block diagram form, of a stereoscopic vision observation device that includes a stereoscopic display unit according to a representative embodiment of the invention, and FIG. 22(b) shows a modified example of the stereoscopic display unit shown in FIG. 22(a). In FIG. 22(a) is shown an image input device I and a stereoscopic display unit 2 where a two-dimensional image or a three-dimensional image from the image input device 1 can be observed without special eyeglasses.

The image input device 1 may include: an endoscope 17a that can image a two-dimensional image or a three-dimensional stereoscopic image; a microscope 17b that can image a two-dimensional image or a three-dimensional stereoscopic microscope image; and /or a computer 17c that can process a tomographic image, such as a CT, an MRI, or a computer graphic image, such as a three-dimensional image that has been constructed based upon these tomographic images. An image source, such as a two-dimensional image or a three-dimensional image which has been imaged by a camera installed in the endoscope 17 or the microscope 11b, a tomographic image, such as a CT or an MRI that has been entered into the computer 11c, or a computer graphic image that has been constructed based upon these toniographic images is constructed so as to transmit the images to a projection device 21 in the stereoscopic display unit 2 via the image control devices 12a, 12b and 12c, respectively.

The stereoscopic display unit 2 may include a projection device 21 and a display panel 22. The stereoscopic display unit 2 shown in FIG. 22(a) is designed so that the projection device 21 projects images to the display panel 22 from above the display panel 22. On the other hand, the stereoscopic display unit 2 shown in FIG. 22(b) is designed so that the projection device 21 projects images to the display panel 22 from below the display panel 22. Alternatively, though not illustrated, the stereoscopic display unit 2 may be designed so that the projection device 21 projects images to the display panel 22 from the side of the display panel 22. Further, in the stereoscopic display unit 2 illustrated, the display panel 22 is constructed to be a reflection-type display panel wherein a viewer views an image carried by light that has been reflected by the display panel 22. In the apparatus shown in FIGS. 22(a) and 22(b), image data (either data of a two-dimensional image or of a three-dimensional image) from an image source is input to the projection device 21, so as to enable an observer to observe the two-dimensional image or the three-dimensional image.

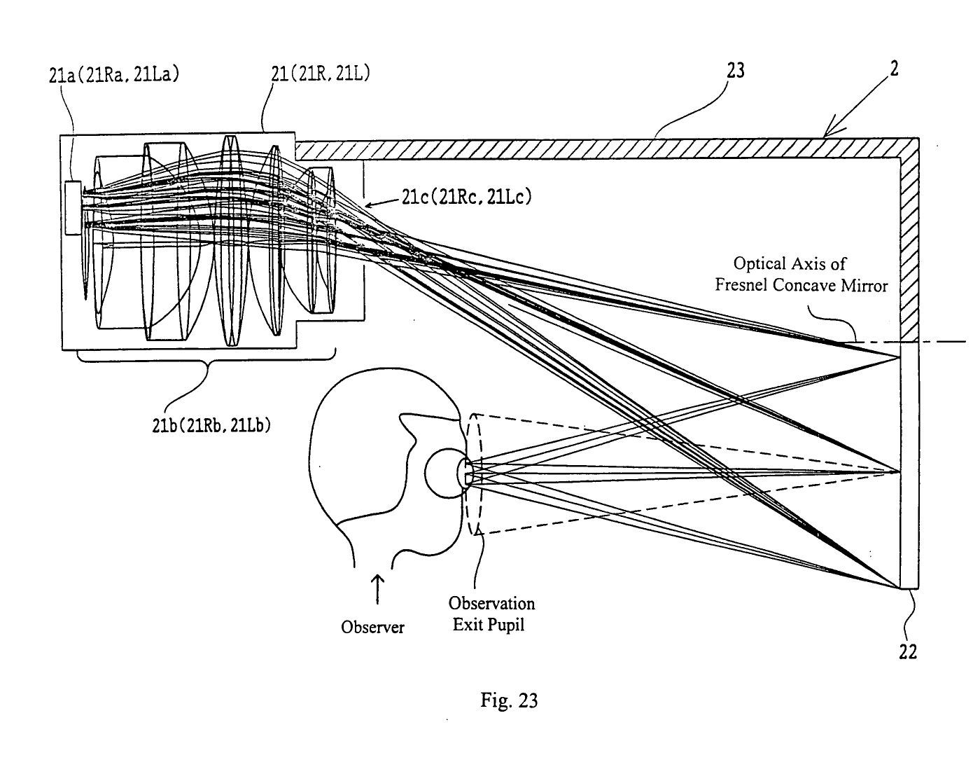

FIG. 23 is a side view that shows, in greater detail the construction of the stereoscopic display unit shown in FIG. 22. The display unit 2 includes the projection device 21 as an image projection means and the display panel 22, both of which are supported by a support arm 23. The projection device 21 includes an image display 21a, a projection optical system 21b and an aperture 21c. Furthermore, in the case of a three-dimensional observation, the stereoscopic display unit 2 is equipped with two projection devices 21R and 21L. Each projection device 21R (21L) is constructed by including an image display 21Ra (21La), a projection optical system 21Rb (21Lb) and an aperture 21Rc (21Lc), respectively.

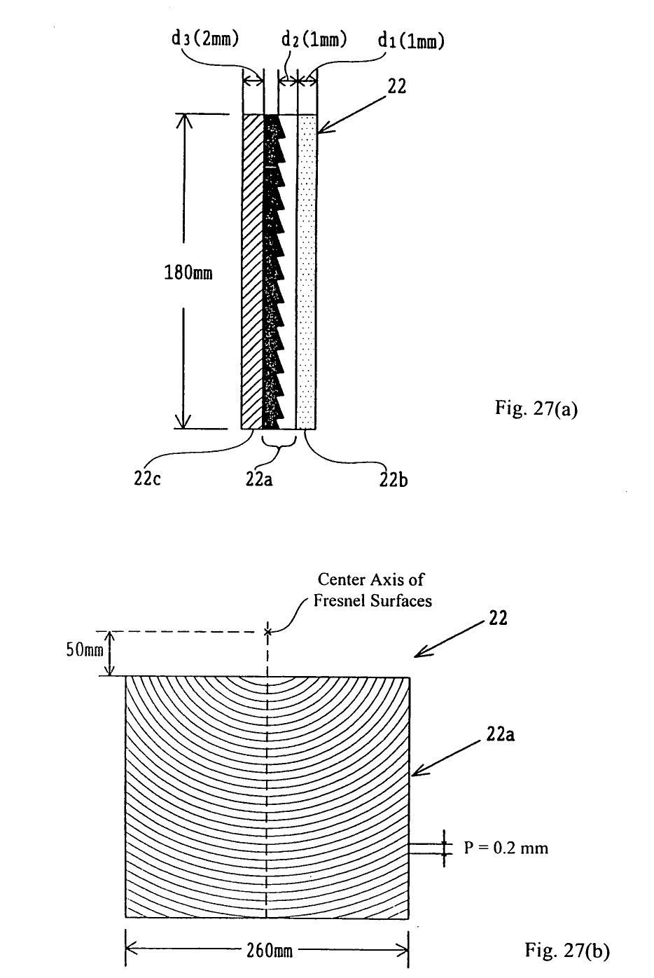

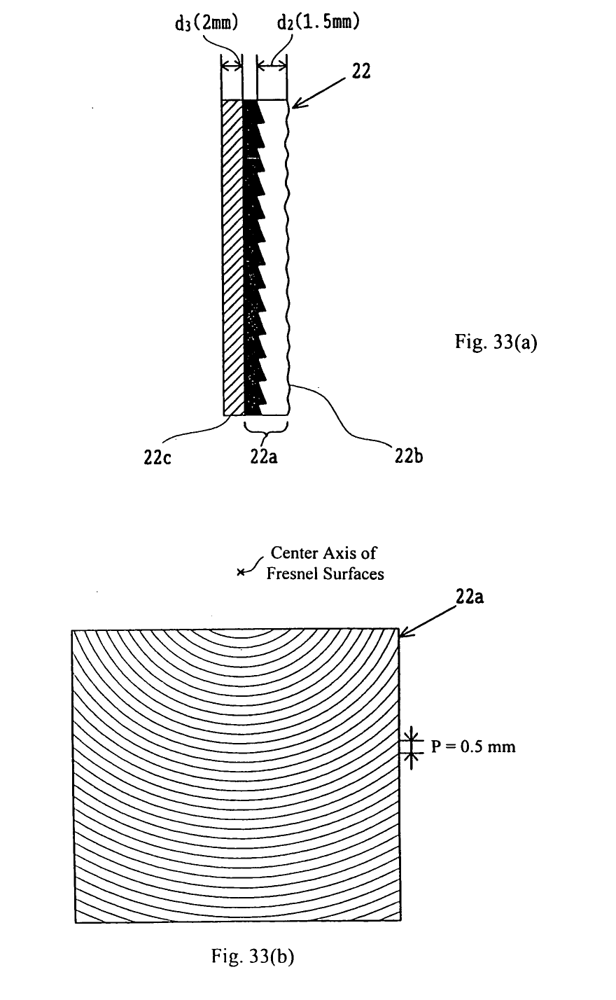

The display panel 22 shown in FIGS. 27(a) and 33(a) each includes a Fresnel concave mirror 22a and a diffuser 22b, 22b′, respectively. FIGS. 27(a) and 33(a) are cross-sectional views that show different designs for the display panel 22 shown in FIG. 23, and FIGS. 27(b) and 33(b) are front views of the grooves of the Fresnel surface of the display panel 22 shown in FIGS. 27(a) and 33(a), respectively. Furthermore, the Fresnel concave mirrors 22a, 22a shown in these figures. are constructed as rear-surface mirrors. An aluminum plate 22c, for reinforcement, is attached onto the side of the mirror behind the rear reflecting surface.

Referring to FIG. 27(a), a diffuser 22b, that in this case is a holographic optical element HOE, may be formed as a film that is arranged on the side of the Fresnel concave mirror that is nearer the projection means. As shown in FIG. 33(a), an alternative to this design for the diffuser 22b′ is to provide a roughened surface on the surface of the Fresnel concave mirror that is nearer the projection means.

As shown in FIG. 23, the stereoscopic display unit 2, is constructed so that the projection device(s) 21 (21R and 21L) forms (form) an image on the display surface of the display panel 22, in the state where the projection device(s) 21 (21R and 21L) is(are) arranged at an eccentric position relative to the center of the display surface of the display panel 22.

As shown in FIGS. 27(b) and 33(b), the Fresnel concave mirror 22a is formed so that its optical axis is positioned outside the display surface of the display panel 22. Further, the Fresnel concave mirror 22a is constructed so as to conjugate (i.e., form an image of) the aperture(s) 21c(21Rc and 21Lc) at observation exit pupils where the image(s) can be observed by the observer positioning his eyes at these locations and looking toward the display panel.

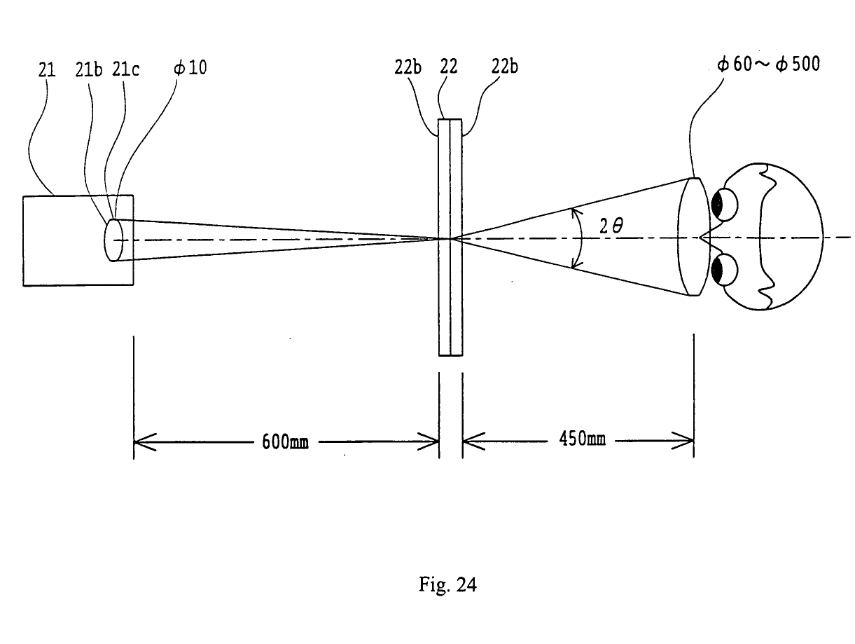

FIG. 24 is an explanatory diagram which illustrates, using unfolded light paths of a reflective display, the formation of exit pupils for observation during two-dimensional observation.

As described above, the display panel 22 is equipped with a diffuser 22b (or 22b′) which enlarges the exit pupils for observation to an appropriate size for ease of viewing while allowing the light to be efficiently directed in the direction of the enlarged exit pupils for observation so as to present bright images to a viewer. Further, the efficient direction of light toward the observation exit pupil positions also enables the brightness of the projection optical system 21b to be reduced (for example, a projection optical system having a large F-number can be used), so that it becomes possible to miniaturize the projection optical system 21b. More specifically, the reduction of the aperture diameter of the projection optical system 21b enables the miniaturization of the projection optical system 21b. This enables, as a light source for projection incorporated in the projection device 21, the use of a low-power light, such as an LED, instead of a mercury lamp or a halogen light source that has a relatively high power consumption.

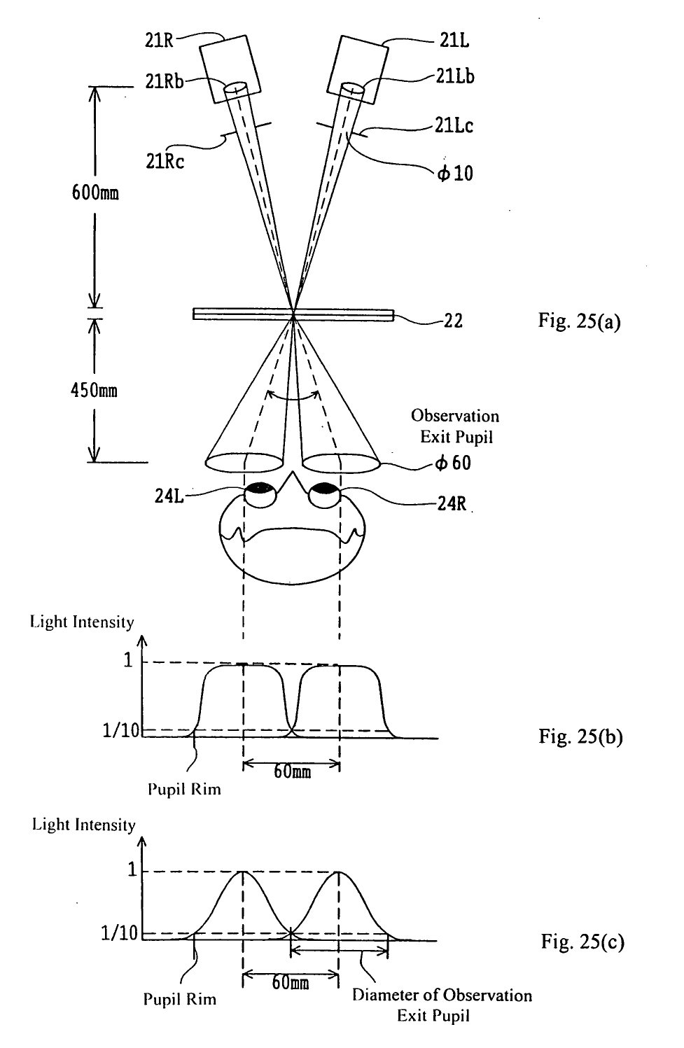

FIG. 25(a) is an explanatory diagram that illustrates, using unfolded light paths of a reflective display, the formation of exit pupils for observation during three-dimensional observation, with FIG. 25(a) being a view from above.

The stereoscopic display unit for three-dimensional observation is constructed so as to arrange the projection devices 21R and 21L as two image projection means side-by-side, with the light from each passing through a respective aperture (21Rc, 21Lc). The two apertures are imaged as right and left observation exit pupils, respectively, and these are then enlarged so as to provide right and left enlarged exit pupils for observation, as discussed above. The positions and the diameters of the right and left observation exit pupils are established so as not to overlap each other.

FIG. 25(b) illustrates the intensity distribution within the right and left exit pupils for observation with a diffuser being used that makes the light intensity within the exit pupils for observation rather uniform. FIG. 25(c) illustrates the intensity distribution within the right and left exit pupils for observation without a diffuser being used, wherein the light within each exit pupil for observation has a Gaussian distribution. In either case, it is important that the light intensity distributions for the right-eye exit pupil and the left-eye exit pupil do not substantially overlap. This is accomplished by sufficiently reducing the light intensity in the tail portions of each light intensity distribution where some overlap occurs. As shown in FIGS. 25(b) and 25(c), the light distributions for the right-eye and the left-eye exit pupils do not overlap within each exit pupil for observation in the regions where the light intensity is greater than one-tenth of the peak intensity. Consequently, it becomes possible to present the images from the right-eye and left-eye projection devices 21R, 21L (FIG. 25(a)) to a viewer's right and left eyes 24R, 24L in a manner such that the right eye does not view images intended for viewing by the left eye and vice-versa, thereby providing stereoscopic viewing without the observer having to wear special glasses to view a 3-D image.

Further, as shown in FIG. 25(a), which illustrates the unfolded light paths in the case of a three-dimensional observation, both the convergence position and the focusing position coincide on the display surface of the display panel 22. Consequently, there is no sense of incongruity upon observation and less eye fatigue is experienced than would otherwise be the case.

Further, the optical element having positive optical power is positioned at the image formation position of the projection optical systems 21Rb and 21Lb. This optical element functions to image the apertures that function as exit pupils of the projectors to positions, herein termed the observation exit pupils, where a viewer may place his right and left eyes 24R, 24L. The optical element having positive optical power has no affect on the formation of the images that are projected via the projection devices 21R,21L. Consequently, even if the position of the optical element having positive optical power is mis-positioned or shifts somewhat from its intended position and/or orientation, no distortion of the observed images will result. Thus, stable, high-quality images can be observed using the present invention.

In addition, in order to provide a display unit and an observation device that are user-friendly by causing less eye fatigue, particularly when viewing stereoscopic image pairs that are perceived as three-dimensional images and, to enable miniaturization to be realized, it is preferable that the construction of the display panel, the projection means and the entire optical system be optimized as follows:

(a) when the optical element having positive optical power is formed of a concave Fresnel mirror, the optical axis of the Fresnel mirror should be positioned outside of the display surface of the display panel 22;

(b) concerning the entire optical system, the panel thickness and the scattering angle are constructed such that the above Condition (1) is satisfied;

(c) concerning the entire optical system, the above Condition (2) is satisfied;

(d) the projection means is constructed so that the aperture ratio is 0.20 or more;

(e) a diffuser that preferably is formed as a hologram film that has both a scattering effect and a refraction effect is used to enlarge the observation exit pupils;

(f) concerning the angles subtended from the enlarged observation exit pupils to both ends of the display panel in the horizontal and vertical directions, the angle subtended in the horizontal direction should be in the range of 6 degrees through 60 degrees and the angle subtended in the vertical direction should be in the range of 4 degrees through 50 degrees;

(g) concerning the observation distance, the observation exit pupils should be positioned in the range of 150 mm through 2000 mm from the display panel;

(h) concerning the images of the exit pupils of the projector that form the exit pupils for observation, the exit pupils for observation should have a diameter in the range of 20 mm through 500 mm;

(i) in the case that the pupils for observation are non-circular, the dimension of the shortest side should lie in the range of 20 mm through 500 mm;

(j) the ratio of the area of the display panel 22 to the display area of the projected images at the image surface should be in the range of 0.5-1;

(k) the magnification ratio of the optical element having positive optical power in imaging the exit pupils of the projectors should be in the range of 0.1-10;

(l) the diameter of the aperture(s) 21c (21Rc and 21Lc) that serve as the exit pupils of the projector(s) should be in the range of 5 mm-50 mm; and

(m) the area of the image display 21a should not exceed 900 mm², and it is preferred that the area of the image display 21a′ does not exceed 400 mm².

Items (a)-(d) above are for obtaining high quality images, item (e) above is for obtaining high quality, stereoscopic images, items (f)-(j) are for the purpose of realizing a user-friendly stereoscopic display unit, and items (k)-(m) are for the purpose of realizing miniaturization of the stereoscopic display unit.

Several more embodiments of the invention will now be described in detail with reference to the drawings.

FIG. 23 is a side view that shows in detail the construction of the stereoscopic display unit relating to an additional embodiment of the present invention. The stereoscopic display unit 2 includes the projection device(s) 21 (21R and 21L) and the display panel 22, both of which are supported by the support arm 23. The projection device(s) 21 (21R and 21L) includes the image display(s) 21a (21Ra and 21La), the projection optical system(s) 21b (21 Rb and 21Lb) and the aperture(s) 21c (21Rc and 21Lc). An image displayed on the image display(s) 21a (21Ra and 21La) is relayed to the display surface of the display panel 22 via the projection optical system(s) 21b (21Rb and 21Lb) after passing through the aperture(s) 21c (21Rc and 21Lc) which function as exit pupils of the projection devices. The light that forms the images on the display surface of the display panel 22 is reflected at the display panel 22 and may be observed by a viewer's eyes that are positioned at the observation exit pupils. As mentioned above, the aperture(s) 21c (21Rc, 21Lc) are conjugated by an optical element having positive optical power so as to form observation exit pupil(s), and the observation exit pupils are enlarged by a diffuser so as to form enlarged observation exit pupils.

The size of the exit pupils for observation is normally designed such that their diameter does not exceed 500 mm in order to ensure that the observed images will have sufficient brightness. Furthermore, the exit pupils of the projectors can be non-circular. In such a case, if the length of the shortest side of the exit pupil for observation does not exceed 500 mm, the observed images will have a sufficient brightness.

FIGS. 27(a) and 27(b) show more details concerning the construction of the display panel 22, with FIG. 27(a) being a cross-sectional view of the display panel 22, and with FIG. 27(b) being a front view of the Fresnel surface of the display panel 22. The display panel 22 is formed of a rear-surface, concave Fresnel mirror 22a as the optical element having positive optical power and the diffuser 22b is formed of an HOE scattering film. Further, the HOE scattering film 22b is arranged on the front surface of the rear-surface concave Fresnel mirror 22a. An aluminum plate 22c for reinforcement is attached to a metal portion that forms the reflective rear-surface side of the concave Fresnel mirror 22a. However, the construction can be such that the aluminum plate 22c is omitted. Further, in this embodiment, the thickness d₁, of the HOE film 22b is 1 mm, the thickness d₂ of the transparent material adjacent the metalized portion of the Fresnel mirror 22athat functions to reflect light is 1 mm, and the thickness d₃ of the aluminum plate 22c is 2 mm.

As shown in FIG. 27(b), the grooves of the Fresnel mirror are formed so that the optical axis of the Fresnel mirror (i.e, the center of curvature of the grooves) is located above the display panel 22. Further, the width of the Fresnel mirror surface (as measured horizontally) is greater than the height of the Fresnel mirror surface (as measured vertically). Therefore the Fresnel mirror surface is oriented in what is termed herein as‘landscape format’. Further, the pitch P (in linear units) of the Fresnel grooves is 0.2 mm in order to ensure that the observed images are of high quality, as discussed above.

With the stereoscopic display unit constructed as above, since the pitch P of the Fresnel grooves is less than the distance subtended by one minute of arc, an observer is unable to resolve the fine patterns of the Fresnel surface, and the image is not degraded. Further, the degree of eccentricity of the Fresnel mirror and the display screen size of the display panel are established so as to not have the optical axis position of the Fresnel mirror 22a be situated within the display surface of the display panel 22. Thus, none of the grooves of the Fresnel surface will be visible nor will any irregular reflection of light that might otherwise occur at the optical axis of the Fresnel mirror surface degrade the image quality observed.

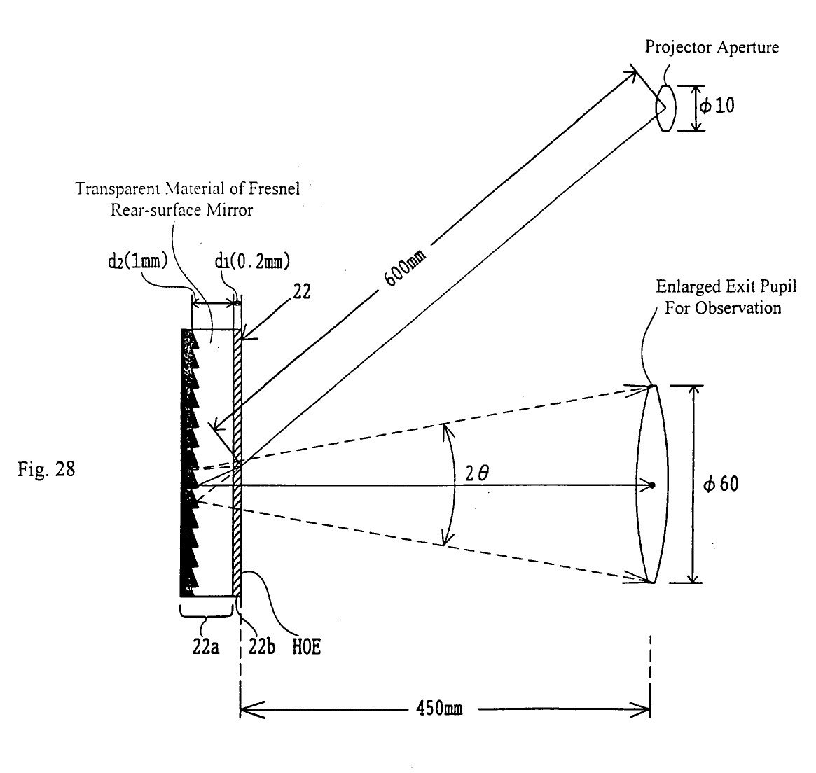

FIG. 28 is a diagram that shows one construction example of the display panel 22 that uses a volume-type, holographic optical element (HOE) as the diffuser 22b for enlarging the exit pupils for observation. Using such a volume hologram, a scattering effect occurs only when the incident light resembles in wavelength and incidence angle the light used to record the light interference patterns of the volume hologram. Thus, a scattering effect can be made to occur for the light when it is first incident onto the hologram, but a scattering effect can be made to not occur for light that has been reflected by the Fresnel mirror surface of the concave Fresnel mirror, since this light will not match in incidence angle the light used to record the volume-type HOE. In a display panel of the above-mentioned construction, an image projected from the projection device may be formed on the HOE surface. Consequently, the image will not be influenced by the thickness d₂ of the transparent material adjacent the reflecting Fresnel mirror surface even though the scattering effect enlarges the observation exit pupils.

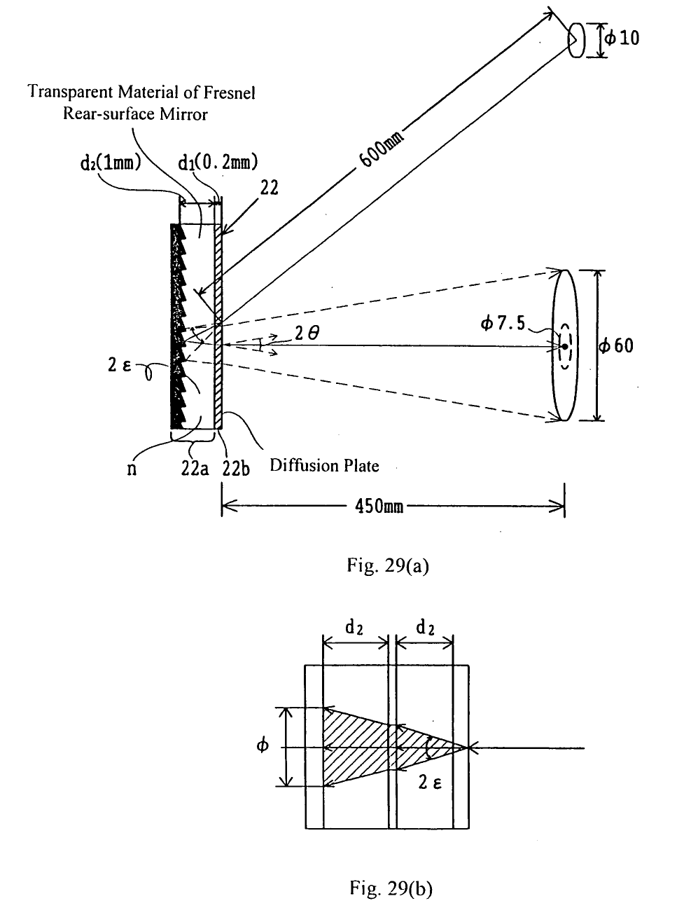

FIGS. 29(a) and 29(b) show another example of a display panel 22 construction wherein a diffusion plate, that serves as a diffuser due to scattering that occurs both when the luminous flux enters and exits, is combined with the rear-surface Fresnel mirror in the stereoscopic display unit shown in FIG. 23, with FIG. 29(a) being a side view of the construction layout and FIG. 29(b) being an explanatory diagram that shows the scattering of the luminous flux caused by the diffusion plate. In the display panel 22 shown in FIG. 29(a), since a scattering effect occurs twice, it is necessary to design the scattering angle differently than in the case where only a single scattering occurs.

The deterioration of the image in the case of using a diffusion plate wherein the scattering occurs twice will now be considered.

Initially, an image from the projection device is formed on the incident surface of the display panel 22. The amount of blur at this time is zero, and the scattering angle of the luminous flux coincides with the numerical aperture of the light beams exiting the projection optical system. 10 As is apparent from FIG. 29(b), wherein the light paths have been unfolded for convenience of explanation, on the incident surface a scattering angle 2ε is added to the numerical aperture of the projection optical system. The light beam is then propagated a distance of two times d₂ from the incident surface to the emission surface via the Fresnel mirror surface, and a circle of confusion having a diameter Φ is generated on the exit surface. At the exit surface, the light is again scattered by an amount 2ε so that the final scattering angle becomes 2θ as illustrated.

If it is assumed that the intensity profile due to one scattering effect is a Gaussian distribution, then two scattering effects will cause the diffusion to have an intensity profile that is also a Gaussian distribution but the new scattering angle will be the square root of 2 (i.e., 1.414) times the initial scattering angle. Thus, the intensity profile due to two scattering effects is different than the intensity profile due to one scattering effect, and will vary depending upon the scattering distribution characteristic. It is reasonable to assume that the scattering characteristic when a luminous flux enters such a diffusion plate and when a luminous flux exits such a diffusion plate will have substantially the same characteristics. Thus, when the scattering angle is defined as the angle between the points on the scattering profile where the scattering intensity has fallen to one-tenth the peak intensity, when two scattering effects occur, the scattering angle will be enlarged by a factor of approximately 1.4 times the scattering angle for a single scattering effect. In computing the diameter of the blur circle that results from two scatterings, a thickness of two times the thickness d₂ of the transparent layer that is adjacent the reflective surface of the Fresnel mirror must be used, since the light travels through this layer twice. Referring to FIG. 29(a), the diameter of the aperture that functions as an exit pupil of the projector is shown as being 10 mm, and the distance to the display surface of the display panel 22 is shown as being 600 mm. In addition, the distance from the diffusion plate to the observation exit pupil is shown as being 450 mm. The image magnification in forming the exit pupils for observation therefore equals 0.75×, and the diameter of the exit pupils for observation therefore equals 7.5 mm. The enlarged exit pupils are to have a diameter of 60 mm, as illustrated, and the final scattering angle is taken as 2 Herein, for the purpose of enlarging the pupils for observation so as to have a diameter of 60 mm, it is necessary to establish the final scattering angle 2 as set forth in Equations (A) and (B) below, wherein it is assumed that d₂<<450:

$$\begin{matrix}20 = {sin}^{- 1} ( 60 / 450 ) & Equation ( A ) \\ \begin{matrix}= {sin}^{- 1} ( 10 / 600 ) + 2 ɛ \cdot {2}^{1 / 2} \\ = 7.7 degrees\end{matrix} & Equation ( B )\end{matrix}$$

where

2ε is the full beam width scattering angle due to one scattering effect.

As noted above, since the full beam width scattering angle 2ε is enlarged by a factor of approximately 1.414 times (i.e., by the factor 2^{1/2}) due to two scattering effects, the full beam width scattering angle 2ε required for one scattering effect is approximately equal to 4.7 degrees.

Further, the blur circle has a diameter ▭ given by the following Equation (C):
Φ=(2·d₂/n)·(sin{sin⁻¹(10/600)+2ε}) Equation (C)
where

d₂ is the thickness of tile transparent optical material adjacent the reflective Fresnel mirror surface,

n is the index of refraction of the transparent optical material adjacent the reflective Fresnel mirror surface,

ε is the half beam width scattering angle (i.e., the scattering angle as measured from the surface normal) due to a single scattering in air, and

Sin⁻¹ (10/600) is the angle between the outer rays of the projected light beam due to the numerical aperture of the projection optical system.

As is apparent from Equation (C) above, the amount of blur (i.e., the diameter Φ of the circle of confusion) depends on the numerical aperture of the projection optical system, the full beam width scattering angle 2ε of the scattering surface, and the equivalent optical distance in air (2d₂/ n) that the light rays propagate within the panel.

Referring to Equation (C) above, when 2ε equals 4.7 degrees, d₂ is 1 mm, and n=1.5, the diameter Φ of the circle of confusion equals 0.13 mm. In other words, the amount of blur for a panel thickness d₂ of 1 mm having a refractive index of 1.5 is about 0.13 mm.

Further, in the stereoscopic display unit shown in FIG. 23, an image can be displayed on an image display using different display formats, such as: VGA (600×480 pixels), SVGA (800×600 pixels), XGA (1024×768 pixels) or SXGA (1280×1024 pixels).

In the case when an image is projected onto the entire surface of the display surface of the display panel 22 having the standard size ‘B5’, the pitch (measured in linear units) as measured in the horizontal direction H and in the vertical direction V for each of the display formats VGA, SVGA, XGA, SXGA is listed in Table 1 below:

TABLE 1

| | |
|---|---|
| VGA: | H - 0.4 mm, V - 0.38 mm |
| SVGA: | H - 0.33 mm, V - 0.30 mm |
| XGA: | H - 0.25 mm, V - 0.23 mm |
| SXGA: | H - 0.20 mm, V - 0.18 mm |

Moreover, the following Conditions (3) and (4) are satisfied so as to obtain high image quality:
0.01<(Δproj/Δeye)<100 Condition (3)
0.01<(Φ/Δproj)<10 Condition (4)
where

Δ proj, Δ eye, and Φ are as defined for Conditions (1) and (2) above. Unless the diameter Φ of the circle of confusion (i.e., the amount of blur) is established as being less than or equal to 2 times Δ proj (when measured in linear units), high spatial frequency information (i.e., fine details) of the image may be lost. The value of Δ proj when using the various display formats listed in Table 1 for the display panel 22 of shown in FIG. 23 (i.e., where (Φ=0.13 mm, 2ε=4.7 degrees, d ₂=1 mm, and n=1.5) is less than 2 times Δ proj. Therefore, there is no deterioration of resolution and no loss of information for any of the display formats listed.

Even though fine details of an image will be lost, as a practical matter for most uses, it is acceptable if the diameter Φ of the circle of confusion is less than 10 times Δ proj (when measured in linear units).

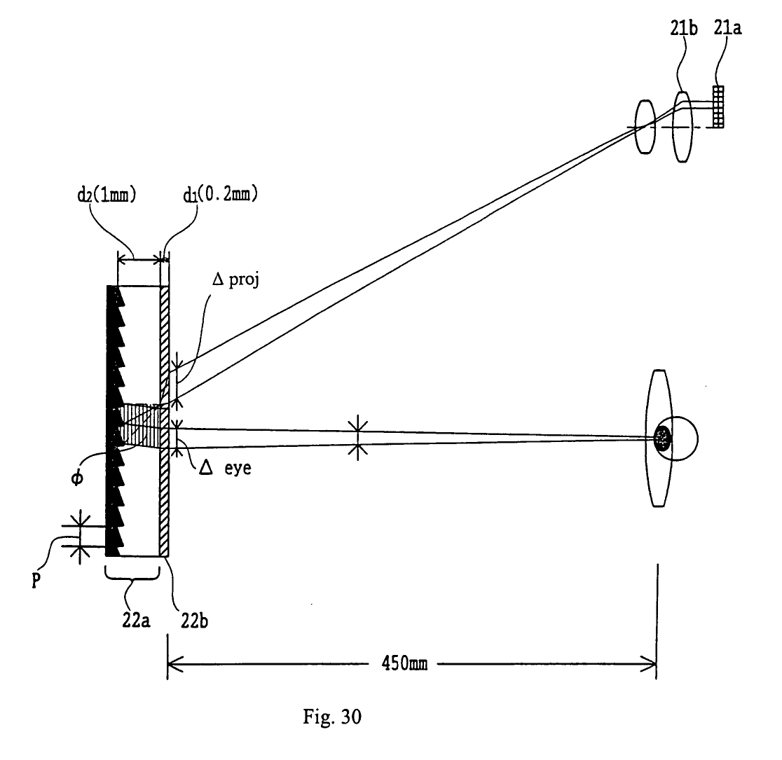

In the stereoscopic display unit shown in FIG. 23, as shown in FIG. 27(b), the groove pitch P of the Fresnel surface is established at 0.2 mm. Further, as shown in FIG. 30, since the resolution, in general, of a human eye is one minute of arc, this angular amount corresponds to 0.13 mm on the display panel 22 when the viewer's eyes are positioned at the exit pupils for observation which are 450 mm from the display panel shown in FIG. 23. Therefore, in this embodiment, Δ eye which is the diameter of the circle of confusion for the human eye observing the display panel Surface from the position of the observation exit pupils is 0.13 mm.

In this embodiment, the groove pitch P (measured in linear units) of the Fresnel surface is made to be approximately the same size as Δ eye. Furthermore, even if the groove pitch P (in linear units) is up to 10 times the value of Δ eye, the display surface will appear to be of acceptable quality in that the grooves of its Fresnel surface, for most observers, will be unnoticeable.

Furthermore, the value of Δ proj (i.e., the pixel pitch, measured in linear units, of the image display surface of this embodiment when projected onto the display panel) is 0.13 mm. Consequently, there is no loss of fine details due to the manner of displaying and viewing the images. Of course, the displayed image can be provided with finer details than can be resolved by a human at a given viewing distance (wherein Δ proj is smaller than the distance subtended by one minute of arc on the display surface as viewed from the exit pupil position(s)). However, there is no benefit to be gained by providing a higher image resolution than can be perceived by a human.

It is preferable that each of the image displays 21a, 21Ra and 21La, have an area, including the perimeter area of the image display, that does not exceed 900 mm². In addition, it is more preferable that this area does not exceed 400 mm². The smaller the projection optical system(s) 21b (21Rb and 21Lb), the more the entire projection device(s) 21 (21R and 21L) can be miniaturized. If the image displays 21a, 21Ra and 21La are large, the projection optical systems 21b, 21Rb and 21Lb and the projection devices 21, 21R and 21L will be large. Further, downsizing the size of the apertures of the projection device(s) allows the projection optical system(s) 21b (21Rb and 21Lb) to be made smaller. In addition, it is desirable that the diameter of the aperture(s) not exceed 50 mm, and more desirable that the diameter of the aperture(s) not exceed 20 mm.

Because the exit pupils are properly sized, the brightness of the images is excellent, without being too bright. For the light source incorporated in the projection device, either a xenon lamp, a halogen lamp, a mercury lamp or an LED can be used.

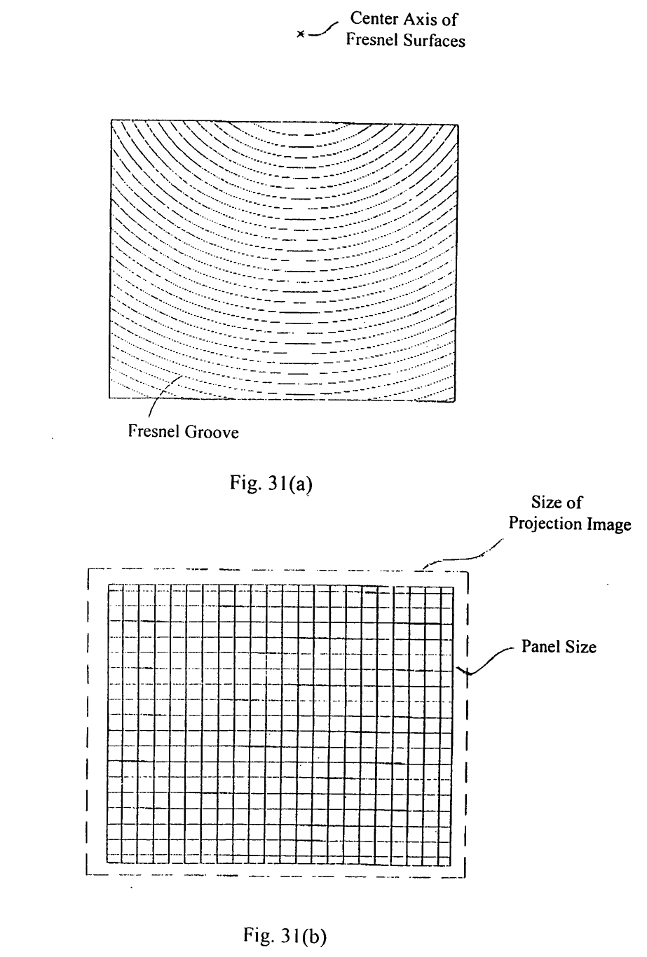

FIG. 31(a) shows the Fresnel surface of the display panel, and FIG. 31(b) is an explanatory diagram that shows the size relationship of an image that is projected onto the display surface of the display panel versus the size of the display panel, wherein the display panel size is smaller than that of the projected picture image. The stereoscopic display unit 2 shown in FIGS. 22(a) and 22(b) does not use a liquid crystal display panel, which requires a frame. Thus, in the present invention, an image may be displayed over the entire surface of the display panel without having a border. This is advantageus in reducing eye fatigue caused by the binocular rivalry when observing stereoscopic images.

Further, an observation can be conducted without noticing a boundary between what is perceived as a three-dimensional image that is displayed on the display surface and the periphery of the display surface of the display panel 22. Therefore, when an operation is conducted with a three-dimensional image being displayed on the display panel so as to show the surgical site, for example, from a different viewpoint so that the surgeon can better understand the circumstances, user-friendliness is excellent.

In order to realize such a situation, it is necessary to employ a reflective-type stereoscopic display unit, and to simultaneously make the size of the image that is projected onto the display panel be larger than the display surface of the display panel 22. When projecting an image onto the display panel 22, care must be taken to ensure that the projected image does not become excessively large, so that the pixels in the image display(s) 21a (21Ra and 21La) are effectively utilized. Consequently, it is preferable that the ratio of the area of the display surface of the display panel 22 divided by the area of the projected display images at the image surface are within the range of about 0.5 -1.0.

Further, it is preferable that the aperture ratio(s) of the image display(s) 21a (21Ra and 21La) be as large as possible. As mentioned above, if the aperture ratio is too small, artifacts appear in the image in that the border area around each pixel will be noticeable, thereby degrading the image quality. In addition, a moir pattern may be noticeable in the displayed image if the difference between the pitch P of the Fresnel optical element having positive optical power versus the pitch of the image display elements of the image display is small. In this case, by designing the aperture ratio to be large, the artifacts of the border around the pixels and of the appearance of a moire pattern will be suppressed.

As shown in FIG. 24 for this embodiment, the distance from the projection device 21 to the display surface of the display panel 22 is constructed to be about 600 mm, and the distance from the display surface of the display panel 22 to the enlarged exit pupils for observation is constructed to be 450 mm. Further, the diameter of the apertures that function as exit pupils in the projection optical system 21b is constructed to be 10 mm, and the diameter of the exit pupils for observation is constructed to be within the range of 60 mm through 500 mm.

Further, the separation between the centers of a viewer's pupils is normally within the range of 50 mm through 70 mm. For the purpose of being able to conduct an observation with both eyes, the diameter of the exit pupil for observation needs to be at least 60 mm. The larger the exit pupils for observation, the greater the freedom the viewer has in selecting observation positions and postures. On the other hand, the larger the exit pupils for observation, the less bright the displayed images will be. Therefore, it is preferred that the diameter of the exit pupils for observation not exceed 500 mm.

As mentioned above, FIG. 25(a) is an explanatory diagram that illustrates (using unfolded light paths of a reflective display viewed from above, the formation of exit pupils for observation during a three-dimensional observation wherein two projection optical systems 21Rb and 21Lb are provided. Right and left exit pupils for observation for viewing by the viewer's right and left eyes, respectively, are formed. By placing his eyes at the exit pupils for observation, a viewer can view stereo image pairs that are formed at an image surface, which substantially coincides with the surface of the display panel 22. It is important that the right and left exit pupils for observation not overlap one another, as this would allow the right eye to see the image intended for the viewer's left eye, and vice-versa, and result in a double image being perceived, instead of a stereoscopic image being perceived. It is desirable to establish the right and left exit pupils for observation as having a diameter in the range of 20 mm through 100 mm, and to arrange the right and left exit pupils for observation so that they do not overlap one another.

As shown in FIG. 25(a) for this embodiment, the right and left exit pupils for observation each have a diameter of 60 mm, and they are arranged at positions where they do not overlap one another but are otherwise situated close to each other.

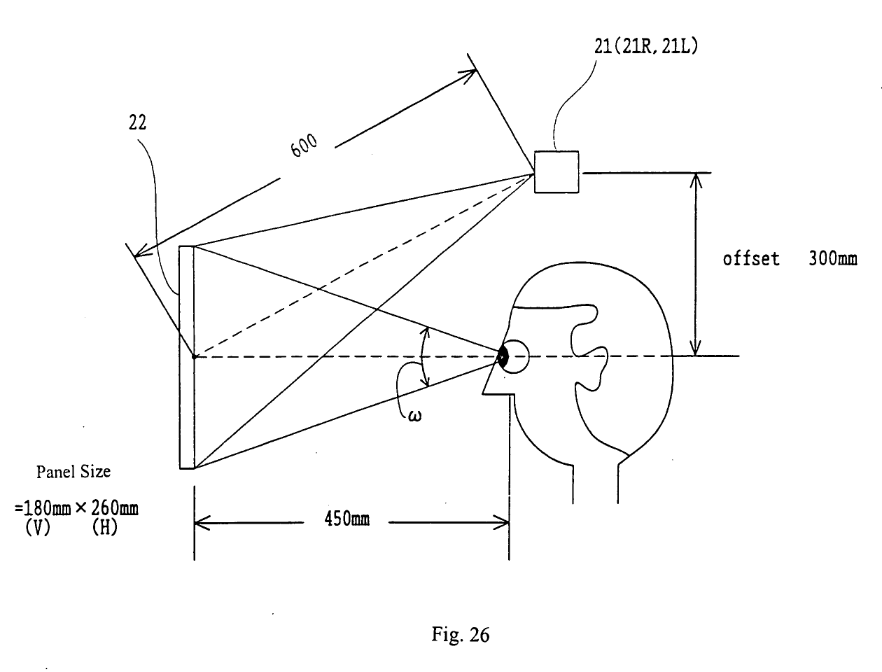

FIG. 26 is a side view that shows the construction layout of the stereoscopic display unit according to this embodiment. The distance from the display panel 22 to the exit pupils for observation is 450 mm, the distance from the display panel 22 to the projection device(s) 21 (21R and 21L) is 600 mm; and the offset from the center of the display surface of the display panel 22 versus the optical axis of the projection optical device(s) 21 (21R and 21L)) is 300 mm.

As discussed above, if the distance between a viewer's eyes and the display panel 22 is insufficient, eye fatigue of the viewer will result. Thus, it is desirable that the distance from the viewer's eyes to the display panel 22 normally be 200 mm or more. Further, it is desirable that the distance from the viewer's eyes to the display panel 22 not exceed 2000 mm. When the distance to the display panel exceeds 2000 mm, the background of the display panel will enter into the field of view, and this will cause eye fatigue due to the generation of a sense of incongruity when stereo images are observed. Further, because the display panel 22 itself must be larger, a viewing distance that exceeds 2000 mm should be avoided.

Next, the affect of the size of the display panel 22 versus the angles of view ωₕ and ωᵥ (with the latter angle being illustrated in FIG. 26 for this embodiment) will be described. The angle of view is the angle from the viewer to both ends of the display panel. In this embodiment, as shown in FIG. 27(b), a display panel having a ‘landscape mode’ orientation is used.

Table 2 below lists the size designator of the display panel, as well as the actual panel size in the horizontal H and vertical V dimensions when oriented in a ‘landscape mode’ view, as well as the angle of view in the horizontal direction ω_{H} and the angle of view in the vertical direction ω_{V} subtended by the opposite edges of the display panel.

TABLE 2

```
(1) A3 Panel size: H - 420 mm, V - 297 mm
    Angle of view ω_{H} in the horizontal direction = 50°
    Angle of view ω_{V} in the vertical direction = 36.5°
(2) A4 Panel size: H - 297 mm, V - 210 mm
    Angle of view ω_{H} in the horizontal direction = 36.6°
    Angle of view ω_{V} in the vertical direction = 26.3°
(3) B5 Panel size: H - 260 mm, V - 180 mm
    Angle of view ω_{H} in the horizontal direction = 32.2°
    Angle of view ω_{V} in the vertical direction = 22.6°
(4) B6 Panel size: H - 130 mm, V - 90 mm
    Angle of view ω_{H} in the horizontal direction = 16.4°
    Angle of view ω_{V} in the vertical direction = 11.4°
(5) B7 Panel size: H - 65 mm, V - 45 mm
    Angle of view ω_{H} in the horizontal direction = 8.3°
    Angle of view ω_{V} in the vertical direction = 5.7°
```

The magnification of the optical element having positive optical power is 450/600=0.75.

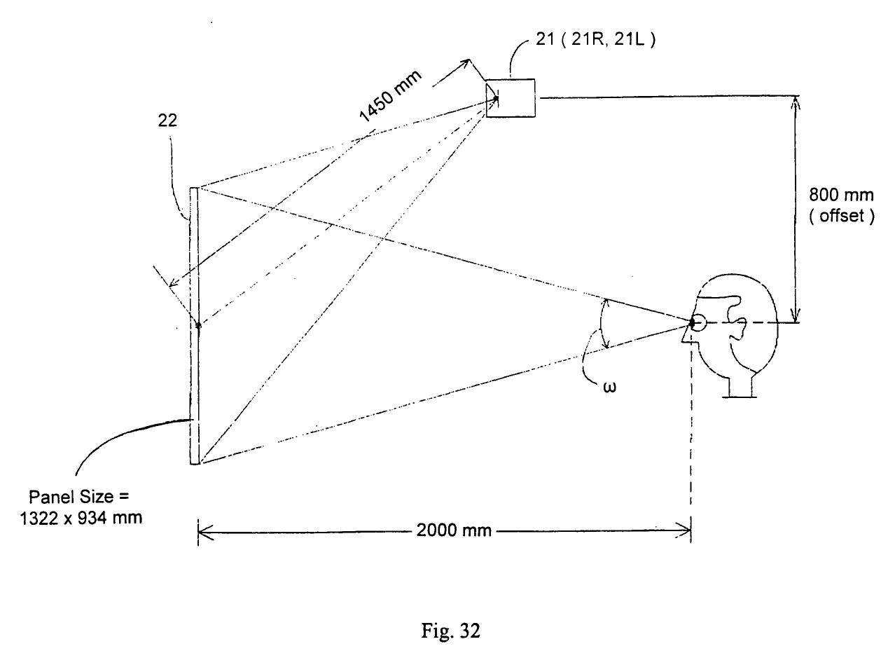

FIG. 32 is a side view that shows the construction layout of a stereoscopic display unit according to another embodiment of the present invention. FIGS. 33(a) and 33(b) show the display panel 22 according to this embodiment, with FIG. 33(a) being a cross-sectional view and FIG. 33(b) being a front view of the Fresnel surface of the display panel 22 of this embodiment. As shown in FIG. 32, in this embodiment the distance from the display panel 22 to the pupil position for observation is 2000 mm; the offset distance of the projection device(s) 21 (21R, 21L) relative to the center of the display surface of the display panel 22 is 800 mm; and the distance between the center of the display surface on the display panel 22 and the projection device(s) 21 (21R and 21L) is 1450 mm.

Next, the affect that the size of the display panel 22 has on the the angles of view ω_{H} and ω_{V} for this embodiment of display panel 2 will be described.

Table 3 below lists the actual panel size in the horizontal H and vertical V dimensions when oriented in a ‘landscape mode’ view, as well as the angle of view ω_{H} in the horizontal direction and the angle of view ω_{V} in the vertical direction subtended by opposite edges of the display panel according to this embodiment.

TABLE 3

```
(1) Panel size: H - 1322 mm, V - 934 mm
      Angle of view ω_{H} in the horizontal direction = 36.6°
      Angle of view ω_{V} in the vertical direction = 26.3°
(2) Panel size: H - 1154 mm, V - 799 mm
      Angle of view ω_{H} in the horizontal direction = 32.2°
      Angle of view ω_{V} in the vertical direction = 22.6°
(3) Panel size: H - 577 mm, V - 400 mm
      Angle of view ω_{H} in the horizontal direction = 16.4°
      Angle of view ω_{V} in the vertical direction = 11.4°
```

Further, as shown in FIG. 33(a), the thickness d₂ of the transparent material of the back-surface Fresnel mirror is 1.5 mm; the thickness d₃ of the aluminum plate is 2.0 mm; and, as shown in FIG. 33(b), the pitch (in linear units) of the Fresnel grooves is 0.5 mm.

In addition, on the concave Fresnel mirror 22a, a diffusion surface 22b′ that provides a scattering effect to an incident light beam is integrally formed on the light incidence surface of the concave Fresnel mirror 22a. More specifically, glass beads are sprayed onto a brass surface that has been polished, and a metal mold that has minute concave surfaces randomly arranged thereon is formed. The metal mold is then used to construct the light incident surface of a layer that is made of plastic material that forms part of the concave Fresnel mirror.

In this embodiment, the distance on the surface of the display panel that corresponds to the resolution of the human eye when viewed from a position 2000 mm distant is 2000 mm times tan (1°/60) equals 0.58 mm.

In the case when an image is projected onto the entire surface of the display surface of the display panel having a size in the horizontal direction of 1322 mm and a size in the vertical direction of 934 mm, the pitch (measured in linear units) as measured in the horizontal direction H and in the vertical direction V for each of the display formats VGA, SVGA, XGA, SXGA is listed in Table 4 below:

TABLE 4

| | |
|---|---|
| VGA: | H - 2.2 mm, V - 1.94 mm |
| SVGA: | H - 1.65 mm, V - 1.55 mm |
| XGA: | H - 1.29 mm, V - 1.21 mm |
| SXGA: | H - 1.03 mm, V - 0.91 mm |

Further, in the case that an image is projected onto the entire surface of the display surface of the display panel having a size in the horizontal direction of 577 mm and a size in the vertical direction of 400 mm, the pitch (measured in linear units) in the horizontal direction H and in the vertical direction V for each of the display formats VGA, SVGA, XGA, SXGA is listed in Table 5 below:

TABLE 5

| | |
|---|---|
| VGA: | H - 0.96 mm, V - 0.83 mm |
| SVGA: | H - 0.72 mm, V - 0.66 mm |
| XGA: | H - 0.56 mm, V - 0.52 mm |
| SXGA: | H - 0.45 mm, V - 0.39 mm |

Furthermore, the magnification of the exit pupil for observation is 2000/1450, which is nearly equal to 1.38.

The other construction, operation and effects of this embodiment are substantially the same as those of the previous embodiment.

The invention being thus described, it will be obvious that the same may be varied in many ways. For example, the Fresnel lens, Fresnel mirror, and/or diffuser may formed holographically, as is known in the art, or a single holographic optical element can serve as both a Fresnel lens and diffuser, or as a Fresnel mirror and diffuser. In addition, low cost copies of such holographic components may be manufactured, as is known in the art. Rather, the scope of the invention shall be defined as set forth in the following claims and their legal equivalents. All such modifications as would be obvious to one skilled in the art are intended to be included within the scope of the following claims.

1. A stereoscopic display unit, comprising:
a projector that projects left-eye and right-eye images via two apertures that serve as exit pupils of the projector onto the same image surface; and
a display panel, that is positioned at or in the vicinity of the image surface, and which includes an optical element having an optical axis and positive optical power that conjugates said exit pupils of the projector so as to form exit pupils for observation; wherein
said display panel has a surface area, and
the optical axis of the optical element having positive optical power is offset so as to lie outside the surface area of the display panel.

2. The stereoscopic display unit according to claim 1, and further comprising: a diffuser that is positioned at the image surface or in the vicinity of the image surface, said diffuser serving to scatter light so as to enlarge the exit pupils for observation to thereby form enlarged exit pupils for observation.

3. A stereoscopic display unit, comprising:
a projector that includes an image display having an image display surface and that projects left-eye and right-eye images via two apertures that serve as exit pupils of the projector onto the same image surface;
a display panel that includes an optical element having positive optical power that conjugates the exit pupils of the projector so as to form exit pupils for observation and a diffuser that scatters light that forms the exit pupils for observation so as to form enlarged exit pupils for observation, the optical element having positive optical power and the diffuser being positioned at the image surface or in the vicinity of the image surface; wherein
the following condition is satisfied:
Φ<10·Δproj
where
Φ is the diameter of the circle of confusion caused by the diffuser, which is determined by the distance from the diffuser to the image surface, as well as by the scattering angle, and
Δ proj is the pixel pitch (measured in linear units) of the image display surface when projected onto the display panel.

4. A stereoscopic display unit, comprising:
a projector that projects images via two apertures onto the same image surface; and,
a display panel that includes a Fresnel optical element having positive optical power which conjugates the two apertures so as to form exit pupils for observation, said display panel further including a diffuser that scatters light that forms the exit pupils for observation so as to form enlarged exit pupils for observation; wherein
both the Fresnel optical element having positive optical power and the diffuser are arranged at, or in the vicinity of, the image surface, and
the following condition is satisfied:
P<10 Δeye.
where
P is the groove pitch (measured in linear units) of the Fresnel optical element having positive optical power; and
Δ eye is the diameter of the circle of confusion on the display surface of the display panel when observed by an observer's eye, said diameter corresponding to 1 minute of arc in terms of angular measure when viewing the display panel from the enlarged exit pupils for observation.

5. A stereoscopic vision observation device comprising;
a stereoscopic display unit including
a projector that projects images via two apertures onto the same image surface, and,
a display panel that includes a Fresnel optical element having positive optical power that is arranged at the image surface or in the vicinity of the image surface, said Fresnel optical element serving to conjugate the two apertures so as to form exit pupils for observation; and,
an image input device; wherein
said display panel has a surface area, and
the optical axis of the optical element having positive optical power is offset so as to lie outside the surface area of the display panel.

6. The stereoscopic vision observation device according to claim 5, and further comprising a diffuser, that is arranged at the image surface or in the vicinity of the image surface, and which scatters light that forms the exit pupils for observation to thereby form enlarged exit pupils for observation.

7. A stereoscopic vision observation device comprising;
a stereoscopic display unit including
a projector that includes an image display having an image display surface and that projects images via two apertures onto the same image surface, and,
a display panel that includes the following two elements positioned at the image surface or in the vicinity of the image surface
an optical element having positive optical power which conjugates the two apertures so as to form exit pupils for observation, and
a diffuser which scatters light that forms the exit pupils for observation to thereby form enlarged exit pupils for observation; and
an image input device; wherein the following condition is satisfied
Φ<10·Δproj
where
Φ is the diameter of the circle of confusion caused by the diffuser, which is determined by the thickness of the panel, as well as by the scattering angle, and
Δ proj is the pixel pitch (measured in linear units) of the image display surface when projected onto the display panel.

8. A stereoscopic vision observation device, comprising
a stereoscopic display unit including:
a projector that projects images via two apertures onto the same image surface, and,
a display panel that includes the following two elements positioned at the image surface or in the vicinity of the image surface
a Fresnel optical element having positive optical power which conjugates the two apertures so as to from exit pupils for observation, and
a diffuser which scatters light that forms the exit pupils for observation to thereby form enlarged exit pupils for observation; and
an image input device; wherein
the following condition is satisfied
P<10·Δeye
where
P is the groove pitch of the Fresnel optical element having positive optical power, and
Δ eye is the diameter of the circle of confusion on the display surface of the display panel as viewed by an observer, said diameter corresponding to 1 minute of arc in angular measure when viewing the display panel from the exit pupils for observation.

9. A stereoscopic display unit, comprising;
a projector that includes an image display and that projects images via two apertures onto the same image surface, and
a display panel that includes the following two elements positioned at the image surface or in the vicinity of the image surface
an optical element having positive optical power which conjugates the two apertures so as to form exit pupils for observation, and
a diffuser which scatters light that forms the exit pupils for observation to thereby form enlarged exit pupils for observation; wherein
the aperture ratio that is projected via the projector is 0.2 or more, said aperture ratio being defined as the summation of the areas of pixels that can be turned to a bright status divided by the display area, where the display area includes the areas that can be turned to a bright status as well as a portion around each pixel that forms a cell in an array of pixels that comprise the display, but excludes the border area of the display.

10. A stereoscopic display unit, comprising;
a projector that projects images via two apertures onto the same image surface, and,
a display panel that includes the following two elements positioned at the image surface or in the vicinity of the image surface
an optical element having positive optical power which conjugates the two apertures so as to from exit pupils for observation, and
a diffuser which scatters light that forms the exit pupils for observation to thereby form enlarged exit pupils for observation; wherein
the diffuser is composed of a holographic optical element that scatters and diffracts the light forming the two exit pupils for observation.

11. A stereoscopic display unit comprising;
a projector that projects images via two apertures onto the same image surface, and,
a display panel that includes the following two elements positioned at the image surface or in the vicinity of the image surface
an optical element having positive optical power which conjugates the two apertures so as to form exit pupils for observation, and
a diffuser which scatters light that forms the exit pupils for observation to thereby form enlarged exit pupils for observation; wherein
an angle viewed from the pupil positions for observation to both ends of the display panel is established to be within the range of 6 degrees through 60 degrees in the horizontal direction, and to be within the range of 4 degrees through 50 degrees in the vertical direction, and
the direction parallel to a line that connects the centers of the right and left exit pupils for observation is the horizontal direction.

12. A stereoscopic display unit, comprising;
a projector that projects images via two apertures onto the same image surface, and,
a display panel that includes the following two elements positioned at the image surface or in the vicinity of the image surface
an optical element having positive optical power which conjugates the two apertures so as to form exit pupils for observation, and
a diffuser which scatters light that forms the exit pupils for observation to thereby form enlarged exit pupils for observation;
the distance from the pupil positions for observation to the display panel is established to be within the range of 150 mm through 2000 mm.

13. The stereoscopic display unit according to claim 12, wherein the diameter of the enlarged exit pupils for observation is established to be within the range of 20 mm through 500 mm.

14. The stereoscopic display unit according to claim 12, wherein the enlarged exit pupils for observation are formed as non-circular regions with a shorter side having a length within the range of 20 mm through 500 mm.

15. A stereoscopic display unit, comprising;
a projector that projects images via two apertures onto the same image surface, and,
a display panel that includes the following two elements positioned at the image surface or in the vicinity of the image surface
an optical element having positive optical power which conjugates the two apertures so as to form exit pupils for observation, and
a diffuser which scatters light that forms the exit pupils for observation to thereby form enlarged exit pupils for observation; wherein
the display panel has a magnification ratio, in conjugating the two apertures so as to form the exit pupils for observation, within the range of 0.1 through 10.

16. The stereoscopic display unit according to claim 15, wherein the projector includes an image display having an area that does not exceed 900 mm², and
the two apertures have a diameter within the range of 5 mm through 50 mm.

17. The stereoscopic display unit according to claim 16, wherein the image display is constructed with an area that does not exceed 400 mm².

18. A stereoscopic display unit, comprising;
a projector that includes an image display and that projects images via two apertures onto the same image surface, and,
a display panel that includes the following two elements positioned at the image surface or in the vicinity of the image surface
an optical element having positive optical power which conjugates the two apertures so as to form exit pupils for observation, and
a diffuser which scatters light that forms the exit pupils for observation to thereby form enlarged exit pupils for observation; wherein
the ratio of the area of the display panel to the area of the projected image at the display panel is within the range of 50% through 100%.

19. A stereoscopic vision observation device, comprising:
a stereoscopic display unit including:
a projector that includes an image display and that projects images via two apertures onto the same image surface, and,
a display panel that includes the following two elements positioned at the image surface or in the vicinity of the image surface
an optical element having positive optical power which conjugates the two apertures so as to form exit pupils for observation, and
a diffuser which scatters light that forms the exit pupils for observation to thereby form enlarged exit pupils for observation; wherein
the aperture ratio that is projected via the projector is 0.2 or more, said aperture ratio being defined as the summation of the areas of pixels that can be turned to a bright status divided by the display area, where the display area includes the areas that can be turned to a bright status as well as a portion around each pixel that forms a cell in an array of pixels that comprise the display, but excludes the border area of the display.

20. A stereoscopic vision observation device, comprising:
a stereoscopic display unit including:
a projector that projects images via two apertures onto the same image surface, and,
a display panel that includes the following two elements positioned at the image surface or in the vicinity of the image surface
an optical element having positive optical power which conjugates the two apertures so as to form exit pupils for observation, and
a diffuser which scatters light that forms the exit pupils for observation to thereby form enlarged exit pupils for observation; and
an image input device; wherein
the diffuser is composed of a holographic optical element that scatters and diffracts the light that forms the enlarged exit pupils for observation.

21. A stereoscopic vision observation device, comprising:
a stereoscopic display unit including:
a projector that projects images via two apertures onto the same image surface, and,
a display panel that includes the following two elements positioned at the image surface or in the vicinity of the image surface
an optical element having positive optical power which conjugates the two apertures so as to form exit pupils for observation, and
a diffuser which scatters light that forms the exit pupils for observation to thereby form enlarged exit pupils for observation; and
an image input device; wherein
the angle viewed from the enlarged exit pupils for observation to both ends of the display panel is established to be within the range of 6 degrees through 60 degrees in the horizontal direction, and to be within the range of 4 degrees through 50 degrees in the vertical direction, and the direction parallel to a line that connects the centers of the right and left pupils for observation is the horizontal direction.

22. A stereoscopic vision observation device, comprising:
a stereoscopic display unit including:
a projector that projects images via two apertures onto the same image surface, and,
a display panel that includes the following two elements positioned at the image surface or in the vicinity of the image surface
an optical element having positive optical power which conjugates the two apertures so as to form exit pupils for observation, and
a diffuser which scatters light that forms the exit pupils for observation to thereby form enlarged exit pupils for observation; and
an image input device; wherein
the distance from the enlarged exit pupils for observation to the display panel is established to be within the range of 150 mm through 2000 mm.

23. The stereoscopic vision observation device according to claim 22, wherein the diameter of the enlarged exit pupils for observation is established to be within the range of 20 mm through 500 mm.

24. The stereoscopic vision observation device according to claim 22, wherein the enlarged exit pupils for observation are formed as non-circular regions with a shorter side having a length within the range of 20 mm through 500 mm.

25. A stereoscopic vision observation device, comprising:
a stereoscopic display unit including:
a projector that projects images via two apertures onto the same image surface, and,
a display panel that includes the following two elements positioned at the image surface or in the vicinity of the image surface
an optical element having positive optical power which conjugates the two apertures so as to form exit pupils for observation, and
a diffuser which scatters light that forms the exit pupils for observation to thereby form enlarged exit pupils for observation; and
an image input device; wherein
the display panel has a magnification ratio within the range of 0.1 through 10 in forming the observation exit pupils.

26. The stereoscopic vision observation device according to claim 25, wherein the projector includes an image display with an image display surface that does not exceed 900 mm² in area, and
the diameter of the apertures is within the range of 5 mm through 50 mm.

27. The stereoscopic vision observation device according to claim 26, wherein
the projector includes an image display with an image display surface that does not exceed 400 mm² in area.

28. A stereoscopic vision observation device, comprising:
a stereoscopic display unit including:
a projector that projects images via two apertures onto the same image surface, and,
a display panel that includes the following two elements positioned at the image surface or in the vicinity of the image surface
an optical element having positive optical power which conjugates the two apertures so as to form exit pupils for observation, and
a diffuser which scatters light that forms the exit pupils for observation to thereby form enlarged exit pupils for observation; and
an image input device; wherein
the ratio of area of the display panel to the area of the projected image at the image surface is within the range of 0.50 through 1.0.
